(19) United States
(12) Patent Application Publication
(10) Pub. No.: US 2026/0181054 A1
(43) Pub. Date: Jun. 25, 2026

(54) SYSTEMS AND METHODS FOR SUBSCRIPTION-GOVERNED REAL-TIME COMMUNICATION CONTROL

(71) Applicant: Peter Manh Pham, San Jose, CA (US)

(72) Inventor: Peter Manh Pham, SAN JOSE, CA (US)

(21) Appl. No.: 19/540,698

(22) Filed: Feb. 15, 2026

Related U.S. Application Data
(63) Continuation-in-part of application No. 17/878,007, filed on Jul. 31, 2022.

(51) Int. Cl. H04L 67/51; H04L 67/306; H04M 3/436

(52) U.S. Cl. CPC H04L 67/51; H04L 67/306; H04M 3/436

(57) ABSTRACT

The present invention relates to systems and methods for establishing real-time voice and video communication sessions between mobile devices without requiring disclosure of personal telephone numbers. A machine-readable symbol, including a QR code, encodes a network-resolvable link associated with a user profile, extension, or community subscription. A cloud-based call service system receives call initiation requests generated from resolution of the link and facilitates routing and establishment of communication sessions over a packet data network. In certain embodiments, the system evaluates caller-related information and stored configuration data to determine whether a call should proceed, be previewed, or be rejected. The platform may support subscription-based extension networks for communities and organizations, enabling visitor-initiated calling through scannable call boards or network devices. Administrative interfaces allow configuration of extensions, services, and communication preferences. The system may further support notifications and alert distribution to coordinated groups of users.

### CROSS-REFERENCE TO RELATED APPLICATIONS

This application is a Continuation-in-Part of U.S. Patent Application No. 20230156111A1, filed Jul. 31, 2022, titled “METHODS AND APPARATUS FOR PLACING CALL USING QR CODE.” The entirety of the parent application is hereby incorporated by reference in its entirety for all purposes consistent with this disclosure.

### NOTICE REGARDING OMITTED MATERIAL

Portions of the parent specification and drawings that are unrelated to the newly claimed subject matter have been intentionally omitted from the present application for brevity and clarity. For example, certain prior embodiments and their corresponding figures have been removed where they are not necessary for understanding or supporting the newly disclosed embodiments. Such omitted portions remain incorporated by reference herein in their entirety to the extent necessary to provide background, enablement, or written description support for common subject matter between the parent and this Continuation-in-Part application.

### INCORPORATION BY REFERENCE STATEMENT

All subject matter disclosed in the parent application that is not reproduced herein, including any omitted text, drawings, or figures, is expressly incorporated by reference in its entirety for all purposes consistent with this disclosure.

### FIELD OF THE INVENTION

The disclosure relates to systems and methods for controlled real-time communication initiation, and more particularly to tag-based call entry points with pre-acceptance signaling, identity verification, and policy-driven routing. In extended embodiments, the invention further relates to networked intercom and service management platforms for communities, businesses, and organizations, including cloud-based administration, extension routing, and mobile communication applications integrated with QR-code technology.

### BACKGROUND OF THE INVENTION

Real-time communication systems, including voice and video calling platforms, are widely used to connect individuals across mobile and networked environments. In many conventional systems, a call request is initiated using a static identifier such as a telephone number, user handle, or fixed endpoint address. Upon receipt of the call request, a recipient device typically provides limited contextual information about the caller prior to call acceptance, such as a name, number, or profile image. In many situations, such limited information is insufficient for recipients to make informed decisions about whether to accept an incoming communication request. This limitation is particularly problematic in scenarios involving visitor access, shared or group-managed endpoints, community-based communication systems, or environments where recipients may not recognize or trust unknown callers. As a result, recipients may either reject legitimate communication attempts or accept unwanted, fraudulent, or disruptive calls.

Some systems attempt to address these challenges by incorporating video communication or caller identification features. However, such systems generally establish a real-time communication session only after a call has been accepted, or otherwise fail to provide a distinct mechanism for presenting rich caller context prior to acceptance. In other cases, systems rely on static routing rules or fixed call forwarding configurations that lack flexibility and do not adapt to varying operational conditions, user preferences, or security considerations. Additionally, conventional communication systems often treat call initiation as a binary event—either a call is connected or it is not—without providing an intermediate control state in which call-related information can be evaluated, filtered, or acted upon before a communication session is fully established. This architecture limits the ability to enforce dynamic policies, apply conditional access controls, or support nuanced call screening workflows. These shortcomings are further amplified in environments such as residential buildings, offices, managed communities, and other controlled-access locations, where communication requests may originate from transient or unknown users and may need to be routed to an individual or department of multiple potential recipients. In such contexts, the absence of configurable call admission control, identity verification mechanisms, and pre-acceptance screening capabilities can lead to poor user experience, reduced security, and inefficient call handling.

Accordingly, there is a need for improved communication systems that provide recipients with enhanced contextual information prior to call acceptance, support flexible and policy-driven call admission decisions, and enable controlled escalation of communication sessions based on configurable criteria. There is further a need for systems that can support visitor-initiated communication using dynamic call entry points while maintaining fine-grained control over how and when real-time communication sessions are established.

To address these limitations, the present invention, originally disclosed in the parent application titled “Methods and Apparatus for Placing Call Using QR Code,” introduced methods and systems that allow mobile device users to initiate calls by scanning a QR code encoding a network-resolvable link. This enables a caller to connect to a callee through a cloud-based call service system without revealing private contact information. This Continuation-in-Part application extends the technology to provide recipients with enhanced contextual information prior to call acceptance, support flexible and policy-driven call admission decisions, and enable controlled escalation of communication sessions based on configurable criteria. There is further a need for systems that can support visitor-initiated communication using dynamic call entry points while maintaining fine-grained control over how and when real-time communication sessions are established.

Building upon that foundation, this Continuation-in-Part application also extends the technology to provide additional services in support of Intercom community users environment. In particular, the invention introduces the PingPad Intercom and Service Management System, which expands QR-code-based call initiation to shared spaces such as apartment complexes, office buildings, hotels, and other organized governmental, business and/or residential communities. Through this system, a visitor can use a PingPad call board equipped with a community-unique QR code and extension-based routing to reach specific residents or departments.

Further embodiments introduce a cloud-based administration platform that enables property or organization managers to register, configure, and oversee call services, user extensions, and community features through a web interface. Additional capabilities include digital bulletin boards for announcements and alerts, walkie-talkie-style radio channels for mobile service teams such as security or maintenance staff, and emergency communication channels for coordinating community-wide responses. Numerous studies indicate that insufficient information and poor coordination frequently result in panic and disorder during emergencies, exacerbating an already critical situation. The instant alert and emergency response mechanisms of the present system are intended to mitigate these problems and enable rapid situation control by response teams.

Together, these advancements transform the original QR-code call system into a comprehensive intercom and service management platform suitable for both individual and enterprise use, combining the convenience of mobile QR communication with centralized control, scalability, and security.

### DESCRIPTION OF RELATED ART

Traditional intercom systems and business phone networks rely on analog wiring, fixed terminals, and dedicated control panels for enabling communication between visitors and residents or among users within a facility. While such systems have been widely deployed in residential, commercial, and hospitality settings, they often require significant installation effort, high maintenance costs, and limited flexibility when reconfiguring extensions or updating contact information.

Modern communication platforms, such as Voice over IP (VoIP) and mobile conferencing applications, have improved accessibility by enabling calls over the Internet. However, these platforms generally require users to share personal phone numbers, email addresses, or social media handles to initiate contact. In multi-tenant or organizational environments, this approach compromises privacy and creates unnecessary exposure of personal identifiers to the public.

Existing QR-code-based solutions provide quick links to web pages or contact cards, but they lack integration with real-time voice and video call routing systems. Furthermore, conventional intercom systems and QR-based visitor systems fail to support dynamic configuration, user-managed extensions, and service-level routing, especially when multiple users share the same facility or organization.

In addition, existing mobile intercom applications do not offer centralized administrative management for businesses to organize users by location, role, or service function, nor do they provide capabilities for group calling, call forwarding, walkie-talkie communication, or emergency channel activation within a unified platform. These limitations lead to operational inefficiency and fragmented communication workflows in modern living communities, offices, and service-based environments.

### PRIOR ART REFERENCES

Conventional intercom and communication systems are typically based on wired installations and analog signaling. These systems require physical control panels and fixed lines, limiting flexibility and scalability. They lack cloud-based configurability and user-driven management of call routing or access permissions.

Modern VoIP and video-calling applications, such as Skype®, Zoom®, and FaceTime®, enable Internet-based communications but require users to exchange personal identifiers, such as email addresses or phone numbers, thereby reducing privacy and making them unsuitable for anonymous or visitor-initiated contact. Furthermore, these applications are not designed for extension-based call routing, group-based service management, or community-level administration.

Existing QR-code technologies, including business card generators and contact-sharing platforms, merely encode static contact data or URLs. They do not integrate with live call service systems to dynamically resolve call sessions or perform routing through centralized servers. Likewise, building intercom kiosks or smart doorbells are limited to fixed, device-specific communication channels, without the ability to manage distributed users, service call groups, or cloud-hosted configurations.

Accordingly, none of the known prior art provides a QR-code-based, cloud-managed intercom and communication system that combines:
1. Secure real-time voice or video communication via network-resolvable links,
2. Administrator-managed extensions and service routing through a centralized platform, and
3. Optional group communication features including call groups, bulletin broadcasting, radio channels, and emergency coordination.

The present invention addresses these deficiencies by unifying visitor and internal communications under a scalable, configurable, and privacy-conscious system architecture.

### Objects of the Invention

It is a principal object of the present invention to provide methods and systems for establishing real-time voice and video communication between mobile devices using machine-readable call tags, including QR codes, without requiring disclosure of personal telephone numbers or reliance on traditional telephony identifiers.

It is another object of the invention to provide a call service system configured to receive call initiation requests generated from resolution of network-resolvable links and to execute signaling procedures for selectively establishing, modifying, or terminating communication sessions over a packet data network.

It is a further object of the invention to provide a pre-session call admission control mechanism that evaluates caller-related identification data and stored configuration parameters prior to allocation of signaling or media channel resources.

It is another object of the invention to provide a policy evaluation subsystem configured to apply per-recipient blacklist records, system-wide historical blocking thresholds, trust classifications, and subscription-level communication policies in determining progression of a communication session.

It is a further object of the invention to provide a multi-state signaling control framework capable of suppressing signaling progression, inserting an intermediate preview state requiring transmission of a live video stream prior to call acceptance, or proceeding directly to session establishment.

It is an additional object of the invention to provide a backend database architecture for storing user profiles, extension definitions, subscription identifiers, service group associations, routing definitions, and call session metadata to support dynamic communication control.

It is another object of the invention to provide a subscription-based communication control platform enabling administrators to define extension routing rules, service group memberships, directory visibility parameters, and communication policies applicable across multiple user devices within a community or organization.

It is a further object of the invention to provide smart call board devices or network terminals configured to display dynamically updateable machine-readable symbols and to initiate communication sessions in coordination with the call service system.

It is an additional object of the invention to provide a notification and alert distribution subsystem capable of transmitting subscription-based notifications to user devices and, in certain embodiments, triggering automated device-level responses based on alert classification.

It is another object of the invention to provide routing mechanisms supporting extension-based addressing, multi-device call groups, and service-based call distribution within subscription-defined communication domains.

It is a further object of the invention to provide support for coordinated communication channels, including group-based call handling communication modes, implemented through a cloud-hosted communication infrastructure.

It is also an object of the invention to support secure communication through authenticated access control and encrypted data transmission over packet-based networks.

It is another object of the invention to provide a scalable, multi-tenant cloud architecture capable of supporting individual users, residential communities, lodging facilities, business organizations, and distributed service teams.

These and other objects are achieved through coordinated control of signaling procedures, routing logic, subscription-defined policies, and device-level communication behavior within a cloud-managed communication system.

### SUMMARY OF THE INVENTION

The present application is a Continuation-in-Part (CIP) of U.S. Patent Application Serial No. 20230156111A1, filed Jul. 31, 2022, titled “Methods and Apparatus for Placing Call Using QR Code.”

The subject matter disclosed herein extends the prior disclosure by introducing a cloud-managed communication control platform, referred to as PingPad, that integrates QR-code-based call initiation with subscription-governed signaling control, extension-based routing, and centralized configuration management across distributed communication endpoints.

In one embodiment, the invention provides methods and systems enabling users of mobile devices to initiate voice or video communication sessions without disclosure of personal telephone numbers. A machine-readable symbol, including a QR code, encodes a network-resolvable link associated with a user profile, extension profile, or community subscription maintained by a call service system. Upon resolution of the link, a call initiation request is transmitted to the call service system, which executes signaling procedures to selectively establish, modify, or terminate real-time communication sessions over a packet data network.

The call service system includes a call server and a policy evaluation subsystem communicatively coupled to a backend database architecture. The backend database stores user profiles, extension definitions, subscription identifiers, trust classifications, blacklist records, and call session metadata. In certain embodiments, call admission is evaluated prior to allocation of signaling or media channel resources, based on stored configuration parameters and caller-related identification data. Depending on the evaluation outcome, the system may suppress signaling progression, insert a preview state requiring transmission of a live video stream prior to call acceptance, or proceed directly to session establishment.

Extended embodiments provide a multi-tenant service management subsystem operating as a configuration control layer for provisioning communication policies across multiple subscription domains. The service management subsystem enables authorized administrators to define extension routing rules, service group memberships, directory visibility parameters, and alert behaviors. Configuration parameters are stored in the backend database and applied by the call service system during runtime signaling evaluation, thereby dynamically governing communication session behavior across distributed user devices.

In further embodiments, the system supports smart call board devices or network tablets configured to display dynamically updateable QR codes and receive visitor input for initiating communication sessions. Such devices may include audio, video, and network interfaces and operate in coordination with the call service system for extension-based routing and controlled session establishment.

The platform may further provide subscription-based notification and alert distribution capabilities, including device-level responses triggered by classified alert conditions. Through coordinated control of signaling procedures, routing logic, and subscription-defined communication policies, the invention provides a scalable and configurable communication control infrastructure suitable for residential communities, lodging facilities, business organizations, and other distributed user environments.

### SUMMARY OF ADVANTAGES

The present invention provides several practical and technical advantages over existing intercom and communication systems. By leveraging network-resolvable QR codes linked to server-side device and user profiles, the system enables secure, real-time communication between visitors and registered users without revealing personal identifiers such as phone numbers or email addresses.

Through its cloud-based architecture, the invention allows for centralized management of multiple communities or business entities, reducing installation and maintenance complexity compared to traditional wired intercom systems. The PingPad Service Management System provides fine-grained administrative control for configuring user extensions, managing extension and service call groups, and broadcasting information to community members from a single interface.

### BRIEF DESCRIPTION OF THE DRAWINGS

The various aspects and embodiments of the present invention will be more fully understood from the following description and the accompanying drawings. The drawings illustrate examples of system architecture, user interfaces, and hardware configurations that collectively embody the functional components of the invention. While specific embodiments are shown and described for clarity, it will be understood that these are provided for illustrative purposes and that other equivalent structures and configurations may be used to achieve the same or similar functions within the scope of the invention.

The above and still further features and advantages of embodiments of the present invention will become apparent upon consideration of the following detailed description of embodiments thereof, especially when taken in conjunction with the accompanying drawings, and wherein:

FIG. 1 illustrates a block diagram of a smart doorbell system for placing call using QR code, according to embodiments of the present invention disclosed herein;

FIG. 2 illustrates a view depicting a call screen, according to embodiments of the present invention disclosed herein;

FIG. 3 illustrates a view depicting a call conversation screen, according to embodiments of the present invention disclosed herein;

FIG. 4 illustrates a view on screen for selecting a tag type, according to embodiments of the present invention disclosed herein;

FIG. 5 illustrates a view of a tag profile editing, according to embodiments of the present invention disclosed herein;

FIG. 6 illustrates a view of a call recipient list, according to embodiments of the present invention disclosed herein;

FIG. 7 illustrates a view of a contact list, according to embodiments of the present invention disclosed herein;

FIG. 8 illustrates a view of a tag profile display on caller's screen, according to embodiments of the present invention disclosed herein;

FIG. 9 illustrates a view of a tag image screen, according to embodiments of the present invention disclosed herein;

FIG. 10 illustrates an image of a tag listing screen, according to embodiments of the present invention disclosed herein;

FIG. 11 illustrates a process of scanning the tag, according to embodiments of the present invention disclosed herein;

FIG. 12 illustrates a display of tag profile after scanning successfully, according to embodiments of the present invention disclosed herein;

FIG. 13 illustrates a method flowchart of incoming call processing by call service module, according to embodiments of the present invention disclosed herein;

FIG. 14 illustrates a caller-side call screen while waiting for call acceptance, according to embodiments of the present invention disclosed herein;

FIG. 15 illustrates a callee-side preview screen, according to embodiments of the present invention disclosed herein;

FIG. 16 illustrates no answer call screen, according to embodiments of the present invention disclosed herein;

FIG. 17 illustrates a method for an incoming call processing by callee platform, according to embodiments of the present invention disclosed herein;

FIG. 18 illustrates a call conversation screen, according to embodiments of the present invention disclosed herein;

FIG. 19 illustrates a call history log, according to embodiments of the present invention disclosed herein;

FIG. 20 illustrates a caller screen after a tag is scanned, where the tag profile is displayed, according to embodiments of the present invention disclosed herein;

FIG. 21 illustrates a Mobile call confirmation prompt on the platform, according to embodiments of the present invention disclosed herein;

FIG. 22 illustrates a Mobile call in-progress, according to embodiments of the present invention disclosed herein;

FIG. 23 illustrates a PINGPAD service platform for placing a call using QR code, according to embodiments of the present invention disclosed herein;

FIG. 24 illustrates a PINGPAD service registration form, according to embodiments of the present invention disclosed herein;

FIG. 25 illustrates a subscription form, according to embodiments of the present invention disclosed herein;

FIG. 26 illustrates the view of a subscription, according to embodiments of the present invention disclosed herein;

FIG. 27 illustrates a method flowchart for a member tag setup, according to embodiments of the present invention disclosed herein;

FIG. 28 illustrates a method flowchart for a visitor call request handling, according to embodiments of the present invention disclosed herein;

FIG. 29 illustrates a caller screen after scanning tag, according to embodiments of the present invention disclosed herein;

FIG. 30 illustrates a pre-printed tag image, according to embodiments of the present invention disclosed herein;

FIG. 31 illustrates a process for claiming pre-printed tag, according to embodiments of the present invention disclosed herein;

FIG. 32 illustrates a screen for adding a tag to the app of the present invention, according to embodiments of the present invention disclosed herein;

FIG. 33 illustrates scanning unassigned tag for tag id, according to embodiments of the present invention disclosed herein;

FIG. 34 illustrates a tag with common QR code and distinct access code, according to embodiments of the present invention disclosed herein;

FIG. 35 illustrates a prompt for access code, according to embodiments of the present invention disclosed herein.

FIG. 36-39 intentionally left blank;

FIG. 40-41 illustrates the Call Group management screens on mobile app.

FIG. 42 illustrates a workflow of policy control engine

FIG. 43-44 illustrates the PingPad visitor call boards using a simplistic custom device and an off-the-shelf network tablet.

FIG. 45 illustrates the PingPad Service Management System architecture integrated with the main system of the present invention.

FIG. 46 illustrates the relationships among database tables used by the PingPad service management backend, including account, subscription, extension, call group, and service tables.

FIG. 47 illustrates PingPad account profile.

FIG. 48 illustrates user interface screens of the PingPad administration portal for account and subscription management.

FIG. 49 illustrates a subscription business information profile.

FIG. 50 illustrates user interfaces for managing extensions.

FIG. 51 illustrates a user interface for managing services.

FIG. 52 illustrates the work flow of the conversation agent for providing automated call-routing service.

FIG. 53 illustrates bulletin board publication user interface

FIG. 54 illustrates the communication policies configuration parameters.

FIG. 55-57 illustrate user interfaces of the PingPad mobile application, including the Home screen for general users, the call group management screen, and the service attendant's Home screen.

The headings used herein are for organizational purposes only and are not meant to be used to limit the scope of the description or the claims. As used throughout this platform, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION OF THE INVENTIONS

The following description sets forth the preferred and best mode of several embodiments of the present invention, including both the original invention and the newly introduced subject matter disclosed in this Continuation-in-Part (CIP) application. It will be clear from the description that the invention is not limited to the illustrated embodiments, but also encompasses various modifications, substitutions, and alternative constructions. Therefore, the present description should be viewed as illustrative rather than limiting. While the invention is susceptible to numerous variations, it is not intended to be restricted to the specific forms disclosed; rather, the invention is to cover all modifications, equivalents, and alternative constructions falling within the spirit and scope of the claims.

In any embodiment described herein, the open-ended terms “comprising,” “comprises,” and similar expressions (which are synonymous with “including,” “having,” and “characterized by”) may, where appropriate, be replaced by the partially closed phrases “consisting essentially of” or by the closed phrases “consisting of.” As used herein, the singular forms “a,” “an,” and “the” shall be interpreted to include bath singular and plural meanings unless expressly stated otherwise.

This application represents a Continuation-in-Part of U.S. Patent Application Serial No. 20230156111A1, filed Jul. 31, 2022, titled “Methods and Apparatus for Placing Call Using QR Code.” The CIP extends the previously disclosed system—which allows users to place voice or video calls by scanning a QR code linked to a network-resolvable resource—by introducing new embodiments including a PingPad Service Management System, a community intercom and extension-based routing platform, and an enhanced mobile application supporting service management, bulletin communication, radio channel coordination, and emergency broadcast features.

The system, as described herein, continues to include a call service server and user management system coupled to a backend database, wherein the database maintains user profiles, group associations, and call session records. The CIP builds upon this foundation by adding cloud-based administrative and operational components, enabling multi-unit communities, organizations, and service providers to manage extensions, services, and users dynamically through a unified web interface.

In the following sections, detailed embodiments are described with reference to illustrative figures that depict the architecture, user interfaces, database structures, and operational processes of both the original call service system and its extended PingPad intercom capabilities.

The description which follows provides both structural and operational details for understanding the invention. Certain well-known processes, communication protocols, and database operations (such as API calls, authentication procedures, and network message handling) are omitted or simplified to maintain clarity. It is also understood that the figures provided are schematic in nature and are intended to convey functional relationships rather than scale or proportion.

The present invention comprises a system and a call app, ‘the app’ for short, executing on mobile phone devices to allow users of the app to place a video call to one or more users of the app by scanning a QR code image. The app often comes in the form of an app pre-installed on a mobile device if the user is a registered user and have the app installed on own device or it could come in the form of a web browser script dynamically downloaded to a mobile device for execution in a web browser context should the user has not installed the app on own device. The app and the script are functionally equivalent in terms of call-making and call-receiving operations and therefore, commonly refers to as ‘the app’. The only difference is how they are executed which is depending on whether the app is installed on the user's device or not. The app and the system are coupled to each another over a computer network such as the Internet.

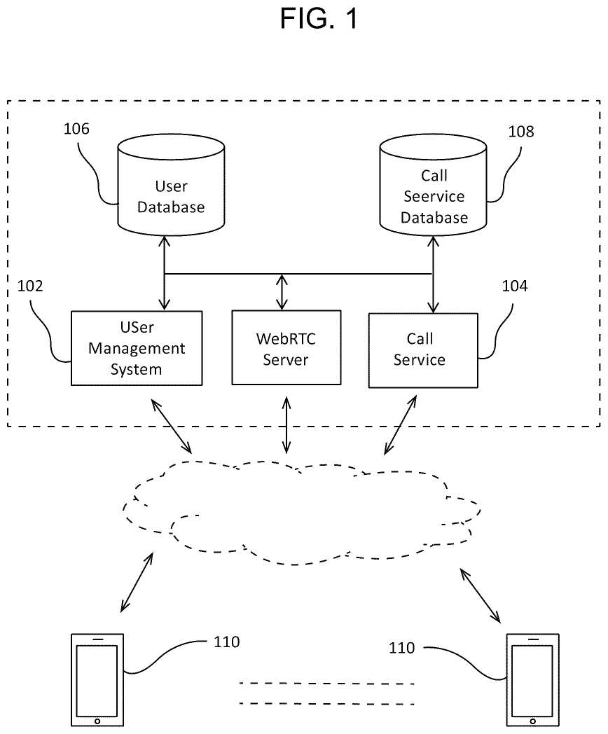

FIG. 1, illustrates a system of the present invention accessible as cloud services and a plurality of the app of the present invention, each executing on an end-user mobile device (110) with access to services over a network cloud such as the Internet. The system comprises a user management system (102) and a call service system (104), aka. ‘Call server’ for short. The service systems are further coupled to the backend database system over a computer network that comprises a user database (106) and a call database (108). The user management system is mainly responsible for registering and authenticating users for service as well as performing administrative user management tasks requested by the system administrator. Once registered, a globally unique user identifier (ID) and associated authentication password are issued to the user in association with a unique identifier, such as the device's phone number or user's email address, for user's identification. During the registration, the user can also input some other user profile information such as name, email address, phone number, avatar image, etc. Additionally, analytic data such as black-listed counter, user's device information, e.g., manufacturer, device type, OS version, etc., are automatically collected and recorded every time the user's logon to the service system for use in determination of operation details as well as analytics. The user information is stored in a respective user profile record of the user profile table of the user database. The call service database maintains at least a call session table, a ping tag table and a black list table.

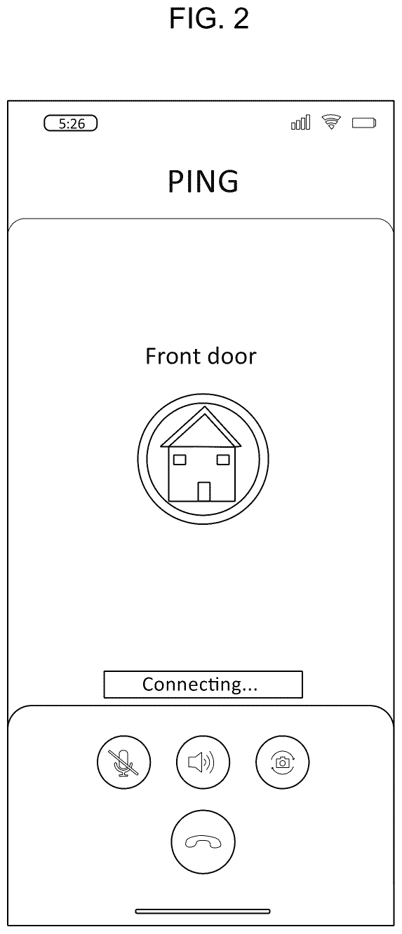

The call session table is used to keep track of past and ongoing calls. A call session record contains information relating to a call, e.g., caller id, ping tag id, call-start and call-end timestamps, call status, list of active call participants, call management and analytic data. The ping tag id is used to retrieve tag settings for processing and call recipient list for signaling. The call participant list contains a list of caller id and qualified call recipient ids. Each participant entry maintains a call status which is either ACTIVE, i.e., join call, INACTIVE, i.e., not join, or LEFT, i.e., hang up. The LEFT status differs from INACTIVE in which it indicates the associated call participant had actually participated in the call, while INACTIVE status indicates a call participant has never participated in the call. Such fine-grained status management is useful for data analytics tool at a later time. The ping tag table contains list of ping tag record entries, each of which stores a unique ping tag id, owner's user id, call status, call-related settings and a list of one or more call recipient. In its simplest form, the call settings specify some call-related options such as how an incoming call will be processed, aka. call routing mode, and the type of call, e.g., audio or video. More options will be added to the call settings in various later embodiments. The black list table stores a list of callers who are black-listed by ping tag owners from calling them using their own ping tags. Each entry in this table contains a timestamp when the black listing event occurs, the user id of the owner of a ping tag, the user id of the black-listed caller and the ping tag id. Once a caller is black-listed against a ping tag, the caller will not be able to initiate call request from the specified ping tag. Also noted that, throughout the description, screen images of SQUAREPING app will be used as examples for easy visualization of the present invention since the app is an actual commercial implementation of the app of present invention as depicted in FIG. 2.

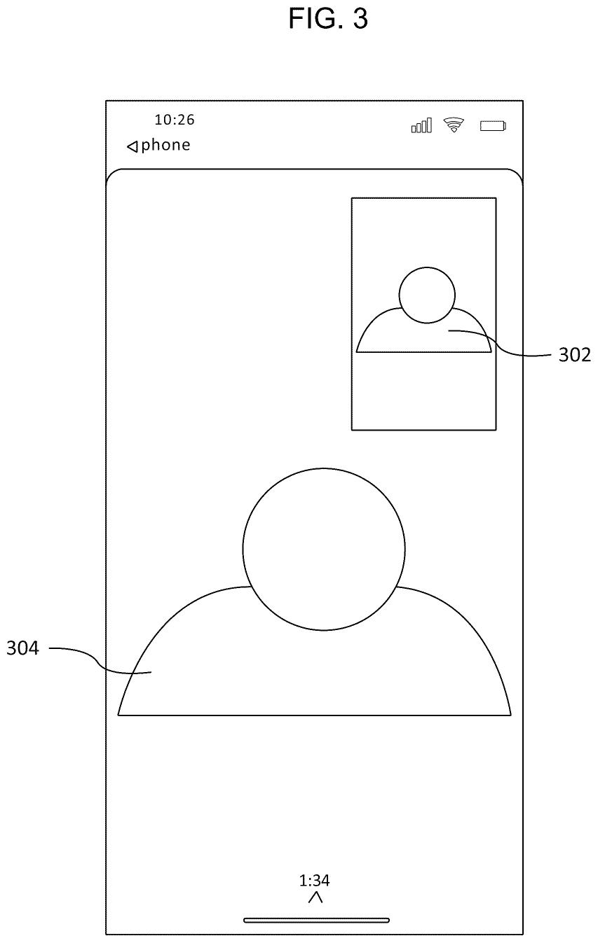

However, they should not be construed as a limitation to the user interface process of the present invention. In fact, those skilled in the art should recognize that there are many ways a user interface can be presented to the users depending on preferences. Today, all mobile devices such as Apple iPhone and Android phone come with a default camera app that can be used to scan a QR code image and translate it to an executable web command (or invoke an app installed on the device) when the user taps on. The end-user mobile device is expected to subscribe to, at least, data network services from mobile phone carriers and, therefore, at minimum, is capable of establishing network access to cloud-based data services and digital video call over the Internet. Those skilled in the art should readily recognize that cloud service deployment is modern technology that enables a service to scale across multiple geographical areas for serving world-wide users with reasonable service response time. In addition to the usual connection to mobile phone network for phone service, the call app of the present invention is required to establish a persistent communication channel with the service system for sending and receiving messages when possible. The communication channel may be over a well-known transport protocol such as TCP or UDP or a message-based push notification service such as Google Cloud Messaging (GCM) or Apple Push Notification (APN) service, depending on the device operating system. By default, a unique push notification token is generated and automatically assigned to a device after a user starts the app on a device. This token is in effect during the lifetime of the logon session and used by the server to address push notification messages to the associated device. The token is recorded in the respective user's record of the user database on the service system and, therefore, retrievable using the user's id. Additionally, on startup, the call server also requests a server key from the push notification service for later use in sending notification messages to user devices. However, since the video calls are made using digital technology over data network, several technologies are available for providing support for such type of calls, from server-centric architecture, e.g., the well-known Jitsi video conference call server, to peer-to-peer video call technology, e.g., WebRTC protocol. Transport connections for data and video channels are necessary to provide support for both protocols. Additionally, the control channel for establishing peer-to-peer WebRTC call uses ad-hoc transport connections for relaying request and response messages, aka. call signals, between the caller, the callees and the call server. On the call server side, the handle of this transport connection, well-known as ‘socket’, is recorded in association with the user id and is retrievable by the call server for use in receiving and sending messages from or to call parties of a call session. Similarly, database structures and database operations such as CRUD, socket operations, API calls, call signaling, media stream construction and relinquishing, etc. are well-known prior arts. Those skilled in the art should be able to implement them with ease. Therefore, the implementation of such well-known prior arts will not be described in details in the description. Also, unless otherwise stated, all communications between the user's device with other users' device or with the said system will be carried out in secure manner using appropriate secure protocols in order to prevent middle-man attack, eavesdrop as well as data alteration while in transit on the network. Throughout the embodiments as described below, whenever the app or the service system receives a message from the other modules of the system, a validation step is automatically performed on the message to ensure given parameters are valid, e.g., the caller, callee(s), the opcode, etc., prior to message processing. This validation process also includes whether a caller is black-listed by the system or by a ping tag owner by querying the black-listed table. Furthermore, cache storage for information dynamically created during the processing of an operation is generally persistent memory unless otherwise stated. The contact list as mentioned in the embodiments is a list of contacts from the phone app contact list. Although, some of them may be registered users of the call service system of the present invention. In call setup over data network like that of the present invention, a call signal, e.g., call request, accept, reject, hang-up, etc., is delivered using either a corresponding REST API call or network request to the call server passing relevant data about the parties in the call and related call session id. Call signal is another form of short message over a data connection, which is used to convey the status of a call at a transmitting party to the call server which is tracking and maintaining the call status of a call session. Additionally, some terms frequently used in the description of the embodiments need to be clarified here to avoid confusion, e.g., ‘mobile device’ is generally described a hand-held device capable of wireless connectivity for placing phone call and establishing data connection over the Internet, ‘caller’ refers to the user who initiates a call, ‘callee’ refers to a call recipient. ‘Call screen’, as depicted in FIG. 2, refers to a graphical user interface for placing or receiving a call and engaging in conversation between call participants and ‘Call conversation screen’ refers to a screen where video streams of caller (302) and callee (304) are displayed as depicted in FIG. 3. ‘Call signal’ in data network implies a message or an API call resulting in a data message used for communicating events between communicating devices, not an analog signal in traditional telecom network. ‘Ping tag’ refers to the QR code associated with a ping tag setup, which is a printed label, or an image of it, containing the QR code of the present invention. However, any codes that are readable by modern mobile device could be used in place of QR code such as a bar code or RFID tag. ‘Ping tag record’ or ‘ping tag setup’ refers to the ping tag configuration stored in the ping tag table. ‘Ping tag owner’ refers to the user or business entity who created a ping tag. ‘Ping id’ or ‘ping tag id’ refers to a unique string of characters identifying a ping tag record. ‘Ping call’ refers to a data call made using the methods of the present invention. ‘Caller app’ refers to the app executing on the user who initiates the call using the methods of the present invention, which may be a web browser instance or a SQUAREPING app instance. ‘Callee app’ refers to the app executing on call recipient's device. A network ‘API call’ can either be a socket API call or a REST API call, whichever is suitable for a particular operation. ‘Unassigned’ or ‘unclaimed’ ping tag refers to the same thing, which is a ping tag that has not yet been associated with a point of contact device.

### Ping Tag

Ping tag is a QR code image to be printed on a print material such as sticker to be posted on an object or a digital representation of the image to be shared online. The code that is used to generate the image is a well-known web URL referencing a computer process on a cloud service system such as SQUAREPING site. An example of such URL is as below:
https://ping.squareping.com/ping/<ping-tag-id>
   where ‘ping.squareping.com’ is the domain name of the site providing service. ‘ping’ is the name of the service and <ping-tag-id> is a computer-generated unique identifier to identify a specific ping tag in the system. Each ping tag is recorded in SQUAREPING system using ping tag table of which record stores the unique identifier of a ping tag and associated operational settings. Before a user can receive a call from a caller using the method of the present invention, s/he must set up and create a ping tag. Using the app, a user sets up desired tag options and a list of one or more call recipient, which often includes the owner of the ping tag. Once a ping tag is setup and created, a corresponding QR code image can then be generated from it and posted where appropriated for others to scan and place a call to the call recipient(s) of the tag when necessary. A call recipient should be ready to receive incoming call from the call service system of the present invention using the app of the present invention.

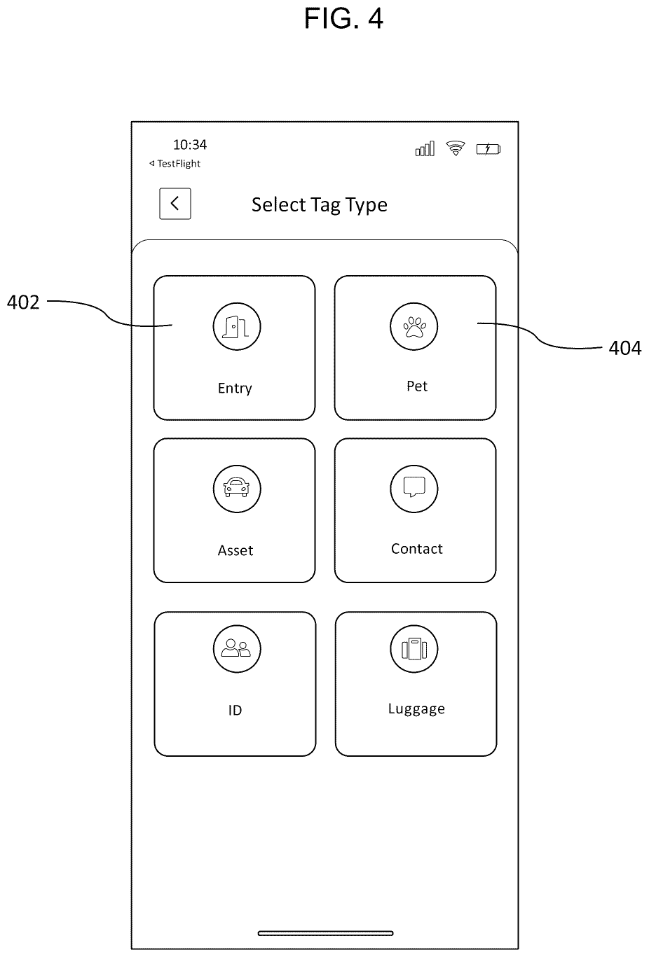

FIG. 4 to 7 depicts a typical ping tag setup process during which the user can specify several options. First, the user selects the type of tag to be created as depicted in FIG. 4. SQUAREPING app provides support for a variety of tag types intended for various applications. Among them are:
Entry—to be printed and applied on entry door for visitors to call resident
Pet—to be printed and applied on pet tag for calling pet's owner
Asset—to be printed and applied on personal belongings and/or business assets such as laptop, phone, computer system, printer, vehicle, bike, motorcycle, scooter, etc.
Luggage—to be printed and applied on travel luggage for recovery
Package—to be printed and applied on shipping package for recovery
ID—to be printed and applied on children's, elderly's, medical patient's identification tag
Contact—to be printed and applied on print materials such as business card, product brochure, flyer, etc. or shared online such as email, website, social networks, etc. as a means for contact in place of or in addition to phone number.

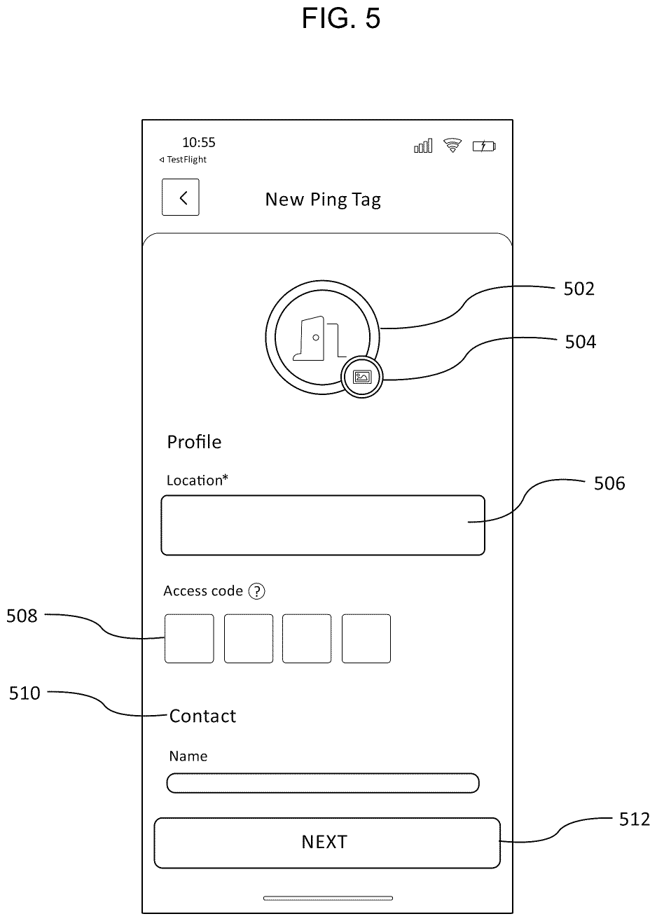

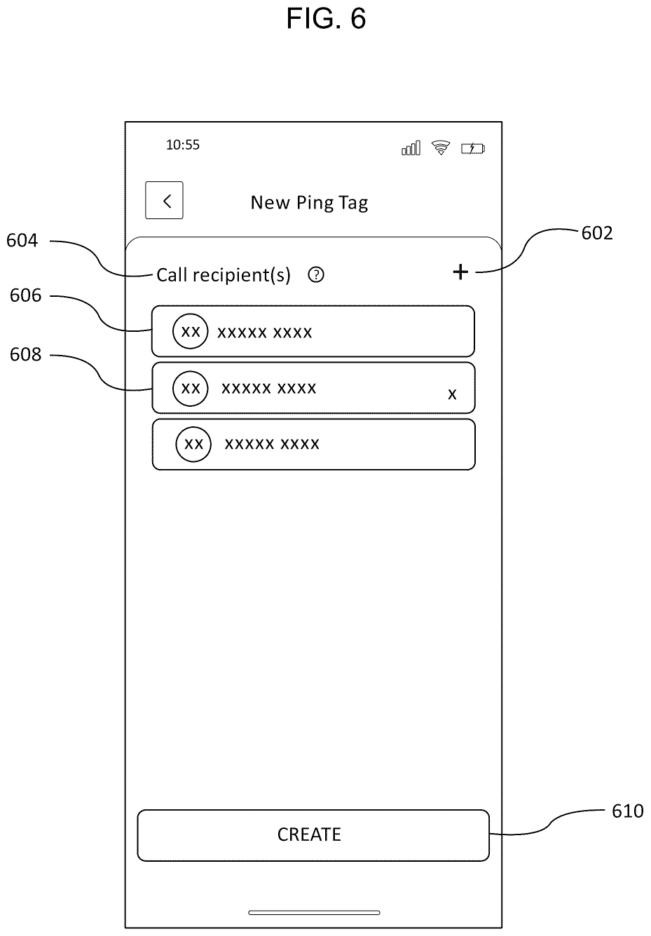

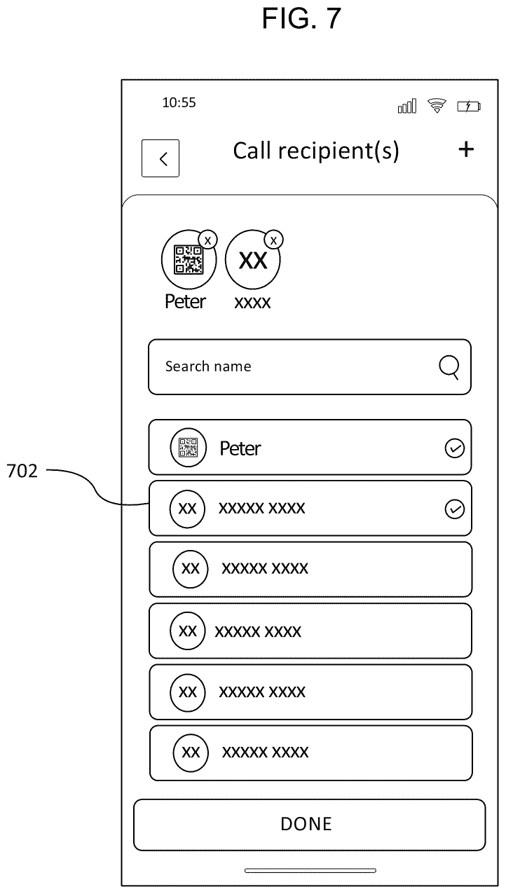

Each type of tags requires a different set of profiles. For example, refer to FIG. 4, ‘Entry’ tag type (402) applies to entry security application, of which profile includes the entry location where the tag will be posted, e.g., entry gate, front door, side door, etc., an optional access code and alternate contact information, which may include name of the person to contact and phone and/or email address, etc. A pet tag (404) profile may include the pet's name, any useful information about the pet and contact information, etc. Asset tag is used for tagging personal belongings and business assets. ID tag is for identification applied to children, elderly, medical patient, personal or business identification used in applications, etc. Contact tag is for personal or business contact. Luggage and package tags are for tagging luggage and shipping packages, respectively. Similarly, other tag types for other applications may have their own profile which vary depending on the specific application of the tag. Assuming Entry tag type is selected, the next screen, refer to FIG. 5, is displayed for the user to specify the tag profile data. For example, as mentioned earlier, the Entry profile includes information such as the entry location (506), an optional access code (506) and an optional image of the entry (502). Access code (508) is a means for avoiding call abuse. If specified, a caller will be required to input a correct access code as set in the profile in order for a call to proceed. As shown in the example, the access code is a 4-decimal digit code. A small button at the bottom right of the profile image is a button (504) that the user uses to select an image from the device's photo gallery or to take a live photo of the entry. There is also an optional contact information aforementioned (510), where the user can specify alternate contact if so desired. The NEXT button (512) leads the user to the next setting screen in the process, which is a list of call recipients as depicted in FIG. 6. By default, the user, i.e., tag owner, (606) is automatically added as a call recipient in the list (604). Other(s) (608) may be added to the call recipient list by the user. The Plus (+) icon (602) allows the user to add other users to the call recipient list by invoking a screen listing the user's phone contacts for selection as depicted in FIG. 7. If selected, the user id of the selected contact (702) will be added to the call recipient list. Thus, a typical ping tag record would contain at least the following information in well-known JSON format:
{
   CreateTimestamp,
   LastUpdateTimestamp,
   TagId, // Unique ping tag id
   UserId, // Tag owner—unique app user id
   TagType, // Entry, Pet, Asset, ID, Contact, . . .
   TagProfile {// Optional profile information
      ProfileImage,
      ProfileInfo, . . . // Vary on tag type
      Contact {// Optional alternate contact details
         Name, // Alternate contact name
         Address, // Alternate contact address
         PhoneNumber, // Alternate contact phone number
         Email, // Alternate contact email address
         SocialNetworkIds // REST API to access alternate contact social network profile
      }
   },
   CallRecipients {
      UserIds // List of call recipients
   }
}

It is noted that users who are added to a call recipient list of a ping tag of another user will be able to view the ping tag on their app so they are aware of their participation as a call recipient of a ping tag but they cannot edit the ping tag settings. Only the ping tag owner can change a ping tag setting. The UserIds field is a shorthand notation of one or more call recipients selected from the contact list of the user's device. Refer to FIG. 7, a contact entry (702), stores the call recipient's name and the contact phone number or email address, whichever is used as user id of the system of the present invention. It is also noted that this method of call recipient selection only applies when the phone number of a device is used as user's id. If other means is used as user's id, such as email address, the phone contact list, which is based on phone number, may not apply. In such case, another mechanism must be used to add call recipient(s) to the list.

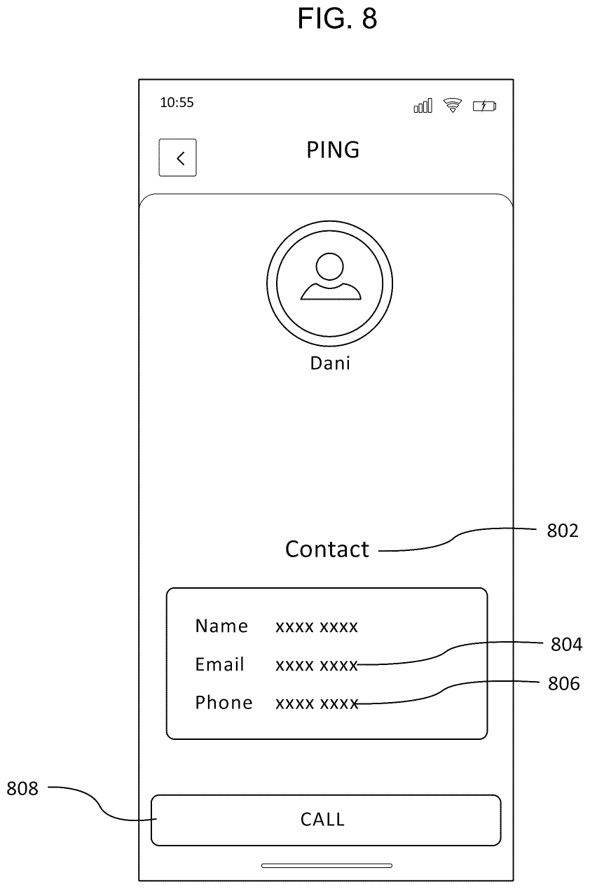

Now, refer to FIG. 8, which displays a tag profile screen of a ping tag after the caller scans the ping tag. This screen displays profile information aforementioned. The alternate contact section (802) is displayed on caller's device screen only when the user specified them during the tag setup process. When on display, the alternate contact information, i.e. phone number (806) and/or email address (804), are automatically linked to the corresponding app on the caller's mobile device, so that if a caller chooses to tap on an alternate contact, the corresponding app on the caller's mobile device is invoked for quick access. Such user interface techniques are well-known prior arts. For example, when the caller taps on the phone number, the app will automatically invoke the default phone app passing to it the phone number of the tag owner for the caller to make the call simply by tapping the call button on the phone app. Similarly, SocialNetworkIds is a list of REST APIs that the caller can use to gain access to alternate contact's profile on social networks such as Twitters, Facebook, LinkedIn, PinkInterest, Whatapp, Snapchat, etc. that the tag owner optionally specifies as alternate contact(s) during the tag setup process. The CALL button (808) is used to initiate a call to the tag owner using the method of the present invention to be described subsequently.

Back to FIG. 6, once the user finishes setting up a ping tag and taps on the CREATE button (610) to complete the setup, the app invokes a Create Ping Tag API to the call service system for creating the ping tag on the service system passing along the ping tag setup information and the user id. Upon receiving this request, the call server generates a unique ping tag id and assigns it to the newly-created ping tag and then saves the ping tag to the ping tag table of the call service database. This, in effect, associates the user id and the ping tag id with the tag setup. The id will be used for ping tag management operations. On success, the call server will return the ping tag id to the app. This id is later used for constructing a ‘ping URL’ by appending the ping tag id to a preset URL as given in the example below:
https://ping.squareping.com/ping/<ping-tag-id>

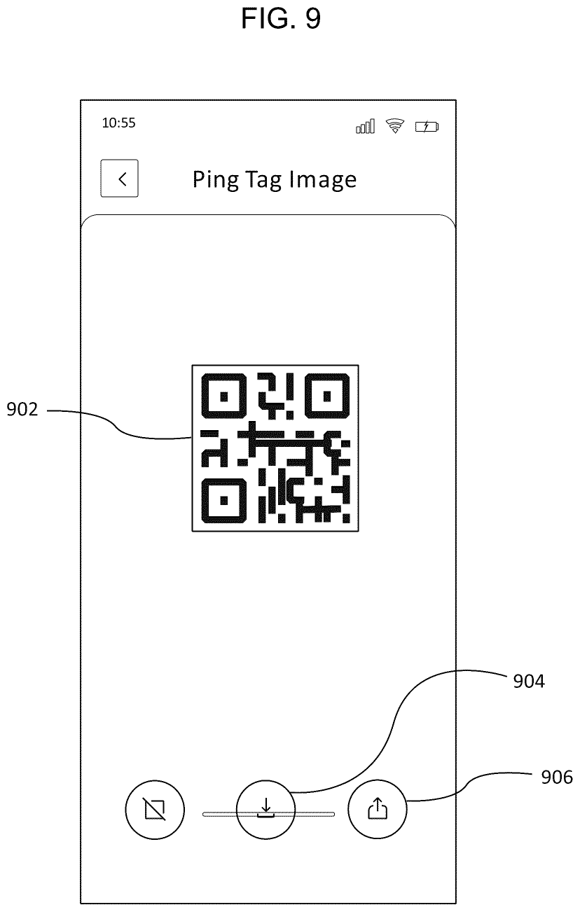

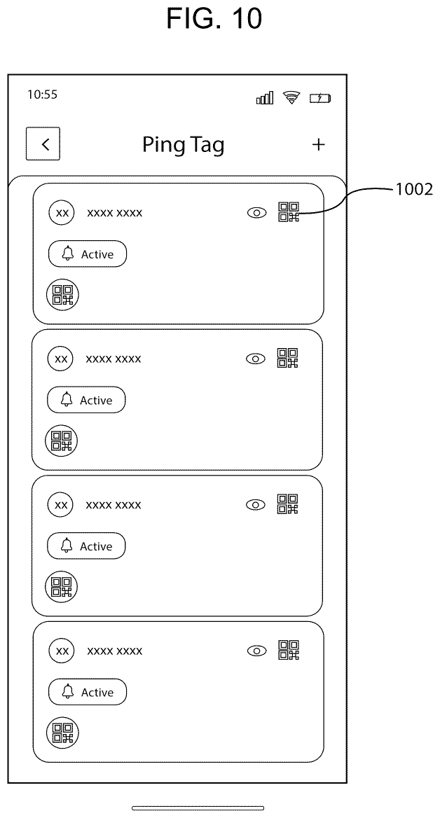

It is noted that the ‘<ping-tag-id>’ denotes the ping tag id previously returned from the call service system. Those skilled in the art should easily recognize that the URL references a web-based call app on the call service system for handling the call and the ping tag id itself identifies the call destination by retrieving the list of call recipients associated with the ping tag. This URL is then used to generate the QR code image when the user needs it. Refer to FIG. 9, which shows a sample QR code (902) generated from a ping tag. The user can download on their device for printing or share with others via other apps, e.g., email, chat, social network, etc. Although, QR code is used for demonstrating the present invention, those skilled in the art should recognize that any code that is readable by mobile device for identifying a Ping tag setup in database for processing may serve the same purpose, e.g. bar code or RFID code. However, bar or RFID code can only encode the ping tag identifier. In this case, the mobile app of the present invention must provide the API URL by means of hard-coding or configuration. Furthermore, the ping tag setup configuration as mentioned above is in its simplest form. Other options could also be added to the ping tag configuration to offer more functionality to the users, e.g., call method (audio or video call), etc. In this embodiment, the call is assumed to be a video call, i.e., call participants will receive and display live video stream of one another on the call conversation screen as depicted in FIG. 3. It is also noted that the tag profile data is optional. If the user skips the tag profile setup, the call will proceed to call establishment phase as described below immediately. After a tag is created as aforementioned, the user can view the tag on a ping tag management screen as depicted in FIG. 10. This screen lists all the ping tags created by the user and generally allows the user to manage them through various operations such as View, Edit, Deactivate, Activate and Delete. The Edit function allows the user to edit a tag profile, call settings and call recipient list. The Deactivate function allows the user to temporarily deactivate a ping tag from receiving incoming calls from the tag. The Activate function will reactivate a deactivated ping tag by enabling it to receive incoming calls again. The Delete function is to delete a ping tag from existence. It is noted that once a ping tag is deleted, the user will never receive call from the tag again. Furthermore, the user can also view the QR code image associated with the tag by tapping on the QR code icon (1002). Back to FIG. 9, while at the ping tag image screen, the user can save (904) the tag image (902) to the device gallery or upload it for sharing with others (906) by uploading it to a web site, social networks or attaching it to an email message.

### 1.1. Ping Call

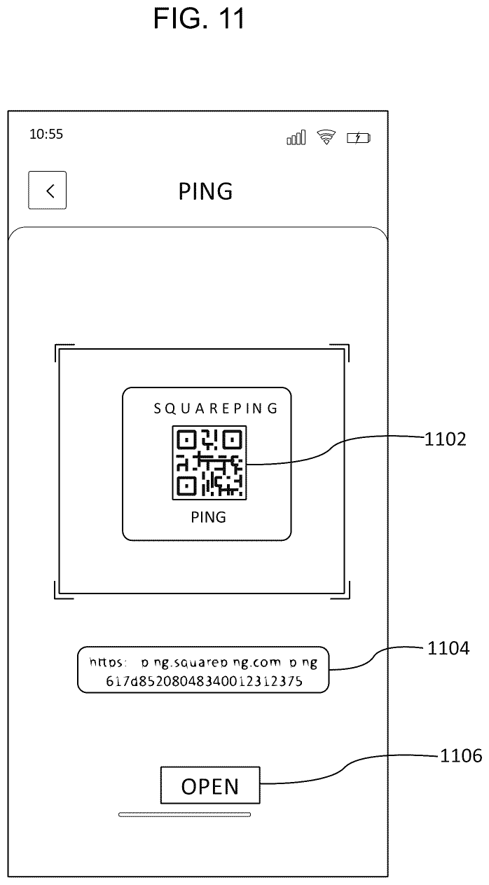

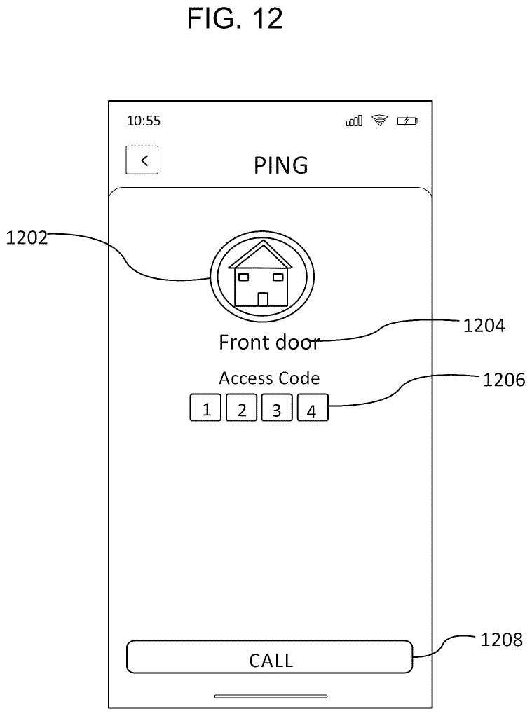

Now, refer to FIG. 11, which demonstrates the scanning of an Entry tag using the back-camera of a user's mobile device using SQUAREPING app. When the user positions the camera at an Entry ping tag (1102) for scanning using the app. As soon as the QR code image is in view of the camera, the app automatically reads and decodes it into the corresponding text string as shown in a popup panel (1104). As described earlier, the text string in this case is a URL for placing a data call to one or more call recipients identified by the ping tag id associated with the ping tag image. The user simply taps on the OPEN button (1106) to proceed with the call establishment process. This action causes the app to initiate an API operation using the aforementioned URL in order to retrieve the ping tag setup from the call service system for display on the next screen, aka. call screen, as depicted in FIG. 12. Since the ping tag is an Entry tag, the tag profile comprises a profile image (1202), the location text (1204) and access code (1206). In this example, the access code was preset, so the caller is required to input a correct access code for the call to take place. Tapping on CALL button (1208) triggers a Call Request API to be issued to the call service system passing the user id and the ping tag id in a call request message as demonstrated below:
{
   “message”: {
      “caller_id”: “XXXXXXXX”,
      “ping_tag_id”: “YYYYYYYY”,
      “opcode”: “CALLREQ”,
      “access_code”: “1234”,
   }
}

It is noted that the call screen displays different information for different tag type. Access code is an optional field, it is prompted for input and verification only if it was preset by the tag owner. All tag types allow the user to specify optional alternate contact information such as email, phone number, social network id, etc. for reaching out to the user by other means if necessary. The alternate contact information is only displayed on the call screen if they are specified during the tag setup process. Such pre-call call screen is designed to give the user more flexibility in designing contact arrangement for specific application. However, those skilled in the art should recognize that, for certain applications, except for prompting the user for access code, proceeding directly to placing the call may be a preferred execution in order to minimize user's interaction and therefore, the intermediate call screen display may not be desirable or necessary in those scenarios.

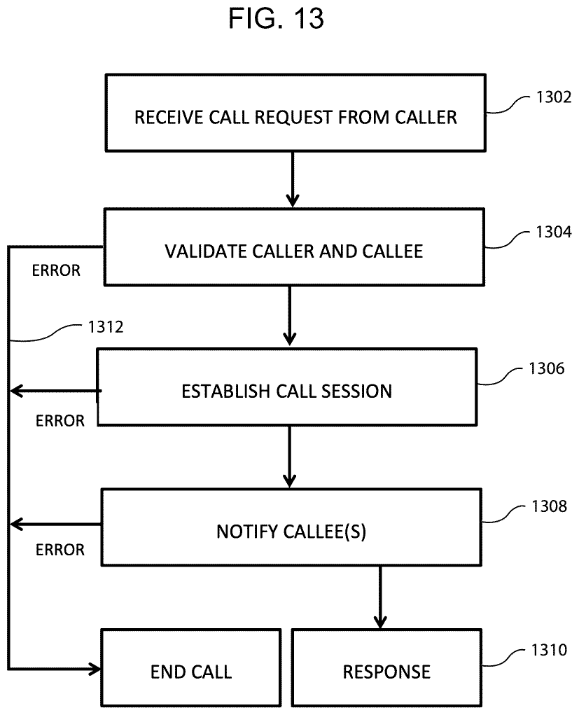

Now, refer to FIG. 13, which presents a flowchart describing call server processing of a call request. Upon receiving the call request (1302), the call server first goes over the parameter validation process aforementioned. Next, the call server then checks whether the caller is already in session with the ping tag by using the ping tag id and the caller id to query the call session table. If such a call session is still in session, i.e., not yet disconnected, the caller would reject the call request with an appropriate error code. Next, the call server then retrieves the call recipient list from the ping tag setup using the ping tag id (1304) and then pulls the call recipient list in the setup. If an access code is given in the call request, it will also be validated against the access code recorded in the ping tag, if any. If the validation process above fails for any reasons, the call server responds to the caller's app with an appropriate error code and ends the call (1312). After a successful validation process and there is at least a call recipient for receiving incoming call, the call server proceeds with setting up a new call session (1306) between the caller and the call recipient(s). To do this, first, the call server generates a unique call session id for the new call session. Next, the call server performs a series of actions to construct the call session management data such as adding the caller id and call recipient id(s) to the call participant list, recording the call-start timestamp, sending an incoming call signal (1308) to the device of every call recipient in the list, passing the caller id and call session id as below:
{
   “message”: {
      “caller__id”: “XXXXXXXX”,
      “opcode”: “INCOMING_CALL”,
      “session_id”: “123456ABC”,
   }
}

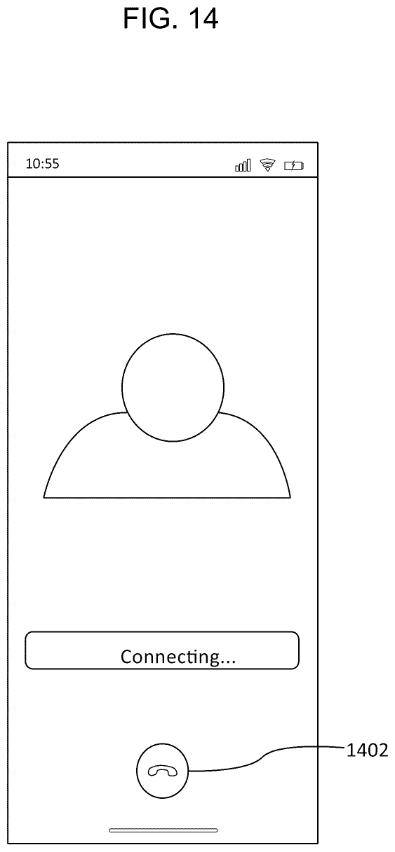

At this juncture, only the caller entry in the participant list is marked as ACTIVE to indicate the caller has joined the call. Conversely, all call recipient entries are marked as INACTIVE. Next, the call server sets a call timeout for disconnecting the call in the event none of the callees answers the call. Lastly, the call server sets the call session status to ‘CONNECTING’ and then responds to the call request with a success code along with the call session id (1310). If there is any error occurs during the call establishment process as described above, the call server will respond to the requesting caller app with a negative response along with an appropriate error code (1302). If the caller's app receives such a negative response, it will terminate the call and display a corresponding error message on the app's call screen so the caller is aware of the call failure. Assuming that the caller app receives a positive response from the call server, the caller app then proceeds with opening a persistent socket connection to the call service system for receiving future call signals from the call server, while it is setting up a live video stream of the caller's front camera and preparing for transmitting to a callee's device once a callee picks up the call. The video stream is transmitted using a video streaming protocol, which may be a server-centric or peer-to-peer protocol as aforementioned. Refer to FIG. 14, which illustrates the user interface screen of the caller app while it is waiting for the call to be accepted by a callee. The screen shows the live front camera view of the caller's device as transmitted to the callee(s)' device. At any time during the waiting period, the caller may hang up the call by tapping on the Hangup button (1402). When this happens, the caller app sends a Call Hang up signal to the call server passing the call session id it received from the call server earlier and closes the socket connection with the call server as well as shutting down the video stream. When the call server receives a Call Hang up signal from the caller app, the call server performs a sequence of actions for shutting down the call, which includes marking the session status as ‘DISCONNECTED’, records disconnect timestamp and sends a Call Disconnect signal to the callee(s)' app to end the call.

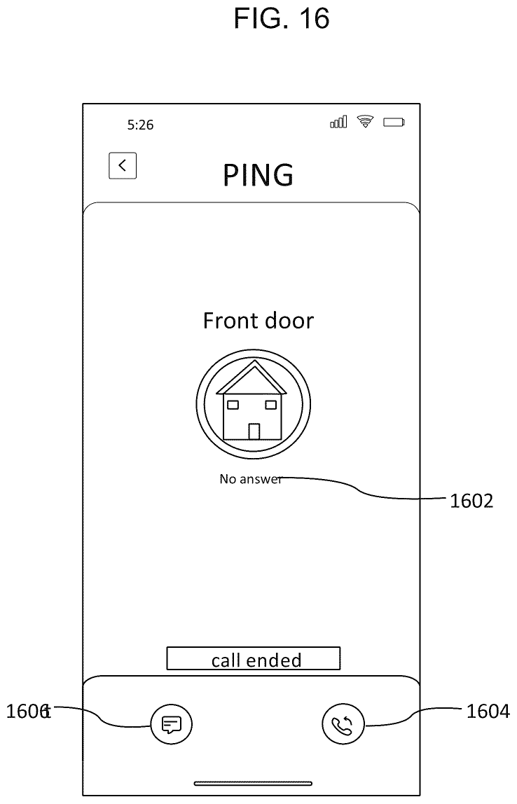

In the event none of the call recipients responds to the incoming event, the call session will eventually timeout causing the call service system to end the call by sending a No Answered signal to the caller app and a Call Disconnect signal to the callee app to end the call session on both ends of the call. As the caller app receives the No Answered signal from the call server, it performs a series of actions to end the call such as terminating the live video stream and disconnects the signaling socket with the call server. Then, it displays ‘No answer’ message (1602) on the call screen as depicted in FIG. 16. The screen also provides access to functions for redialing (1604) as well as leaving a message to the callee (1606) as a convenience to the user. The message will be delivered to callee(s) through notification mechanism available on mobile phones. Similarly, when the callee app receives the Call Disconnect signal, it stops ringing or playing preview video stream and releases all resources it holds such as socket connection with the call server, preview video stream, etc. and then displays a call-end screen on the device screen.

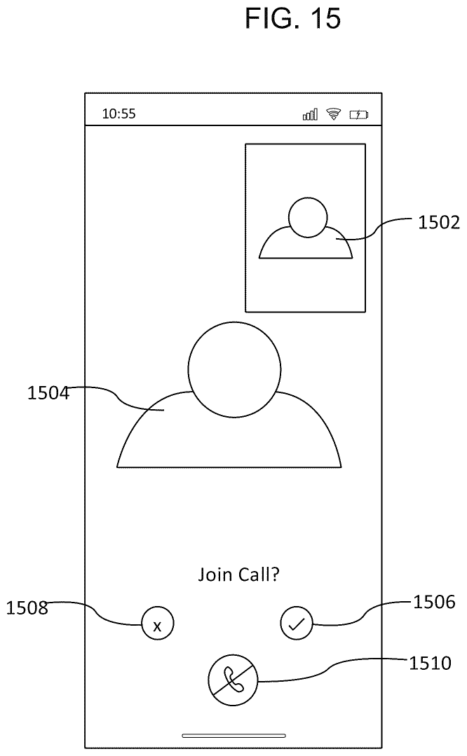

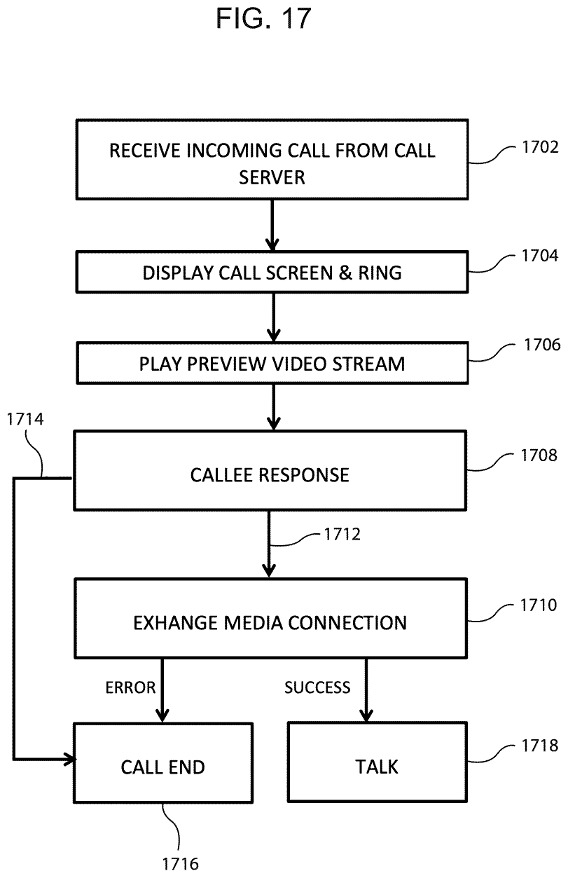

Now, refer to FIG. 17, when a callee's device receives the incoming call notification, the callee taps on the notification to start the app. Once started, the app displays an incoming call screen where the callee can either picks up the call or rejects it, while the incoming call continues to ring. The callee app also opens a socket connection with the call server for receiving future call signals from the call server. If the callee picks up the call, the callee app sets itself up for receiving and playing the live video stream from the caller (1706) as depicted in FIG. 15. This live video stream of the caller (1504) allows the callee (1502) to peek at the caller for identifying the caller as a safety measure. At the same time, the callee app also prompts the callee whether to accept (1506) or reject (1508) the call. It is noted, at this juncture, that the call establishment has not yet been completed between the caller and the callee. Therefore, the caller is not aware that the call has been picked up. The caller's screen will stay the same as depicted in FIG. 14 until the callee accepts or rejects the call. Optionally, the callee can also block (1510) a caller if so desired. Blocking a call from a caller will cause the call to be rejected and the caller to be permanently black-listed from placing call from the ping tag. It is noted that the same process as described above also happens on the device of every callee in the recipient list of a ping tag when an incoming call arrives. Back to FIG. 17, in the event a callee accepts the call, the callee app sends a Call Accept signal passing the call session id, to respond to the request (1712) as given in the example below:
{
   “message”: {
      “callee_id”: “YYYYYYYYY”,
      “session_id”: “123456ABC”,
      “opcode”: “CALL_ACCEPT”,
   }
}

When the call server receives this signal, it looks up the call session table using the call session id, assuming the call session status is still CONNECTING, the call server changes the call session status to ‘CONNECTED’, records the call-start timestamp, marks the accepting call recipient entry in the call participant list as ACTIVE, then sends both the caller app and accepting callee app a Call Connected signal.
{
   “message”: {
      “session_id”: 123456ABC,
      “opcode”: “CALL_CONNECTED”,
   }
}

When the caller and callee apps receive the Call Connected signal, they both start establishing and exchanging video and audio streams for entering conversational screen. Once the call has been accepted by callee, the call server sends a Call Disconnect signal to all other callees' device and terminates the socket connections with them, effectively blocking the other callees from any further interactions. When a callee app on a callee's device receives a Call Disconnect signal, it performs a series of cleanup operations for ending the call on the device as aforementioned. In the event the callee rejects the call (1714), a Call Reject API (call-hang up signal) will be sent to the call server as below:
{
   “message”: {
      “callee_id”: “XXXXXXXX”,
      “session_id”: “123456ABC”
      “opcode”: “CALL_REJECT”,
   }
}

Upon receiving this signal, if the callee is the only call recipient, the call server changes the call status to ‘DISCONNECTED’ and then sends a CallDisconnected signal to the caller app for it to end the call (1716) as aforementioned. Otherwise, the call server will continue to wait for other call recipients' response until the call is timed out.

Back to FIG. 15, in the event the callee wishes to block incoming call from the caller, he or she taps on the Block Call button (1506). This action will trigger the app to issue a CallBlock signal, as given in the example below, to the call server and then execute a cleanup operation for ending the call.
{
   “message”: {
      “callee_id”: “YYYYYYYYY”,
      “session_id”: “123456ABC”
      “caller_id”: “XXXXXXXX”,
      “opcode”: “CALL_BLOCK”,
   }
}

Upon receiving this signal, the call server adds the caller id and the ping tag id associated with the call session to the black list table, which, in effect, prevents the caller from placing call using the ping tag in the future. Next, it sends a CallDisconnected signal to the caller's device to end the call. It is noted that only the owner of the tag would have the privilege of blocking an incoming call. Back to FIG. 17, assuming that the call was accepted, the caller's and callee's app will start exchanging live video and audio streams in accordance to the in-use protocol, i.e., server-centric or WebRTC peer-to-peer, (1710). Once the media stream connections are successfully established between the call parties, the caller and the callee can start talking to one another (1718). Those skilled in the art should readily recognize that the media stream negotiation and exchange processes are well-known prior arts, e.g., WebRTC, server-centric Jitsi video call server, etc. While the underlying media stream hand-shaking procedures may be slightly different from one architecture to another, the overall call signaling sequence as described in this embodiment is very much the same. Similarly, the call control operations represented by the call control buttons are also well-known prior arts.

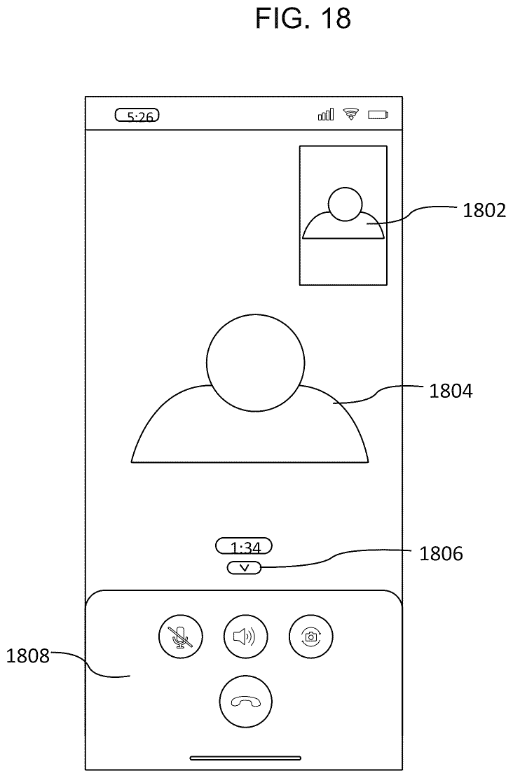

Refer to FIG. 18, which demonstrates the call conversation screen on the callee's device when a call is successfully established between the caller and callee. The caller screen similarly displays the video streams of both communicating parties. The smaller video window on the top right of the screen (1802) displays the video stream of the device owner, in this case, the callee, while the main video window (1804) displays the video stream of the other call party. There is also a expand/collapse toggle button (1806) on the screen for the user to gain access to the call control panel (1808). When the user taps on this button when the call control panel collapsed, the control panel will expand to display a number of control buttons that the user can tap on to control various call settings such as mute/unmute the microphone, enable/disable speaker, flip front/back camera producing the video stream, stop/start video stream, hang up the call, etc. Those skilled in the art should also recognize that other prior-art functions could be added to enhance user's experience while the call participants are in conversation mode, e.g., sharing location, sharing photo, video, image or document, etc. Later, when either the caller or callee hangs up the call, the app will send a CallHangup signal as given in the example below:
{
   “message”: {
      “participant_id”: “NNNNNNNN”, // Caller or callee id
      “opcode”: “CALL_HANGUP”,
      “session_id”: “123456ABC”
   }
}

to the call server who then relays the signal to the other call party, effectively forcing both ends of the call to shut down own media streams and end the call. Meanwhile, the call server updates the status of the call session as ‘DISCONNECTED’ and records a call-end timestamp for the call session.

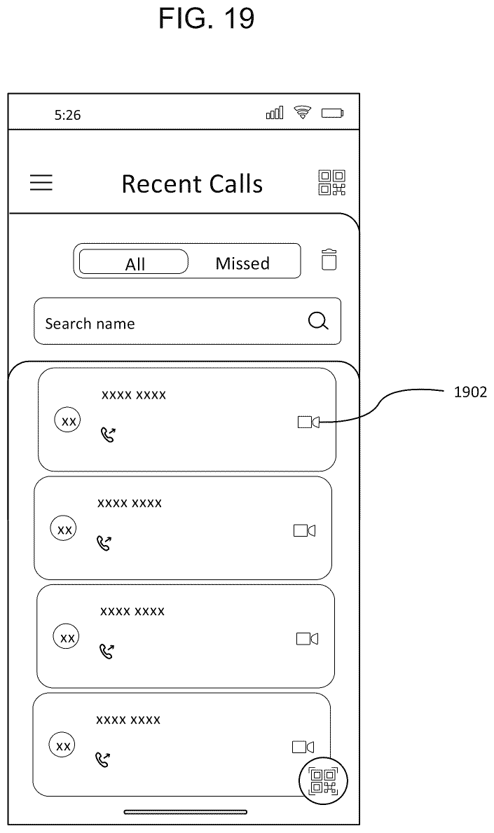

It is noted that, as a convenience to the app user, the app will log all incoming/outgoing calls for review and redial/callback (1902) by the user when needed as depicted in FIG. 19. Furthermore, although the app demonstrates a text message can be sent to a call recipient when there is no answer or when the call recipient is on another call session, those skilled in the art should recognize that voice and/or video message could be implemented in place of or in couple with the text message to give the user more options. The implementation of such types of messages are well-known prior arts. Typically, when such call failure occurs, the app could prompt the user to record a voice or video message, then upload the message to a cloud storage location determined by the call service system and then send a notification message to the call recipient with a URL link representing the location of the message embedded so that the call recipient can gain access the message when s/he receives the notification message. This message link could also be alternately or additionally recorded in the missed call session for the call recipient to access by going through the call history at a later time.

### 1.2. Call Mode

This embodiment describes a video call using a ping tag setup. At times, user may want a ping tag call being an audio call instead of video call for various reasons. Similarly, in some situations, user may prefer call to be made on mobile network instead of the Internet. Thus, in another mode of operation, a new ping tag setting, aka. Call Mode, is introduced so that the user can choose whether incoming ping calls coming from a tag is handled as an audio or video Internet call or mobile call. If the call mode of a ping tag is set to Video Call, incoming calls will be handled as previously described in the embodiment. In the event the call mode is set to Audio Call, incoming calls will be handled as an audio call only. That means the establishment and exchange of video streams for playing on the conversation screen are not needed and therefore, will be suppressed. If Call Mode is set to Mobile, the caller call will be made using the call recipient's mobile phone number instead. In this case, the call service system will provide the call recipient's phone number to the caller app for it to invoke the default phone app on the caller's mobile device passing the call recipient's phone number to it. In any cases, the preview video stream is still being played on the preview screen of the callee's device so that the callee can still peek at the caller prior to accepting an incoming call. After a callee accepts a call, the caller app will drop the live video stream to that particular callee's device, while the other callee devices continue to receive and play the preview stream until the call is either timed out, accepted or rejected.

### 1.3. Ping Mode

In another mode of operation, in case the call recipient list contains more than one entry, the present invention allows a user to select a call routing mode from a new ping tag setting, aka. Ping (or Call Routing) Mode. This setting gives the user more control of how an incoming call to be processed by the call service system. Thus, in this mode of operation, the ping tag setup record is extended to allow for this setting. The call routing mode dictates how a call request is being routed by the call server to a group of call recipients and accordingly, how to process them. There are three ping modes: ‘One-on-one’, ‘Conference’, or ‘Hunt’. ‘One-on-one’ mode is as described in the previous embodiment, i.e., the call server will notify all call recipients in the call recipient list of an incoming call request; however, the first callee picks up the call will take over the call. On the other hand, the ‘Conference’ mode will give all call recipients the option whether to participate in the call. This mode of operation is often known as conference call. Call processing handling for an audio/video conference call is a well-known prior art except for the handling of the preview video stream of the present invention. In prior art video conferencing, any call recipients can join the call at any point in time during the lifetime of a call. Thus, the present invention in this mode of operation must also provide support for this traditional mode of operation. Therefore, the preview video stream of the caller would continue to play on the device of any callees who has not picked up the call regardless of whether any other call recipients has joined the call or not. When a callee decides to join the call, the call server will mark the callee entry in the participant list of the call session as ACTIVE. Simultaneously, the call server also relays the CallAccept signal it received from the new participant to the existing ACTIVE participants of the call. This signal will trigger the app on the receiving device to exchange media streams with the new participant's device and, if successful, update their own conversation screen to additionally play the video stream from the new participant. Similarly, the app of the new participant also plays the video stream of other ACTIVE participant(s) on its conversation screen. Meanwhile, callee(s) who have not yet decided to join or reject the call continue to see the caller's preview video stream playing on their screen. Later, when a call participant hangs up the call, the app on the participant's device sends a Call Hang up signal to the call server. Accordingly, the server will mark the hang-up participant status as LEFT. At the same time, it also relays the Call Hang up signal to all remaining call participants' device. Upon receiving the Call Hang up signal, the app on their device will stop playing and also relinquish the corresponding media streams associated with the leading participant on their own device. It is noted that those skilled in the art should recognize that, as a call participant joins (or leaves) a call, the conversation screen would be dynamically re-partitioned to make room for showing the video stream of the new participant on the screen or reclaim the space for better view of remaining participant(s). The ‘Hunt’ mode is also well-known telecom call routing mode, in which the call server will ‘hunt’ for the first responder sequentially in a pre-determined order instead of broadcasting the incoming call request to all call recipients at once. That is the call server first dispatches the incoming call request to the first call recipient in the list that is not engaged in any call sessions. When an in-progress call request to a callee's device is timed out, the call server disconnects the call request and automatically re-route the incoming call to the next free callee's device in the listed order and so on . . . until either a callee picks up the call or the list is exhausted. The ‘hunt’ will also stop as soon as a callee accepts the call. In the event, no callee in the call recipient list accepts the call, the call server will send a Call Unanswered signal to the caller app for it to end the call. As such, the processing of an incoming call in ‘Hunt’ mode is very much similar to ‘One-on-one’ call, i.e., allow call to be established with only one call recipient, except for the additional ‘hunting’ process implemented by the call server as described above. It is noted that if Call Mode was set to Mobile, the Ping-Mode is fixed to one-on-one as other modes are intended for Internet call only.

### 1.4. Preview Mode

In some applications, such as lost & found, it may not be necessary for the call recipients to peek at the caller of an incoming call. Thus, to make user interaction simpler in such applications, in another mode of operation, the present invention extends the ping tag settings to include a setting namely, Preview Mode. Toggling this mode will enable the user to control whether an incoming call from a ping tag should precede with a live preview video stream of the caller. The call server is required to inform the caller's app whether this option is enabled in its response to a call request so that the caller's app will act accordingly. If the option is disabled, the caller's app will not attempt to construct and transmit a live video stream of the front camera of the caller's device as previously described.

### 1.5. Alternate Contact

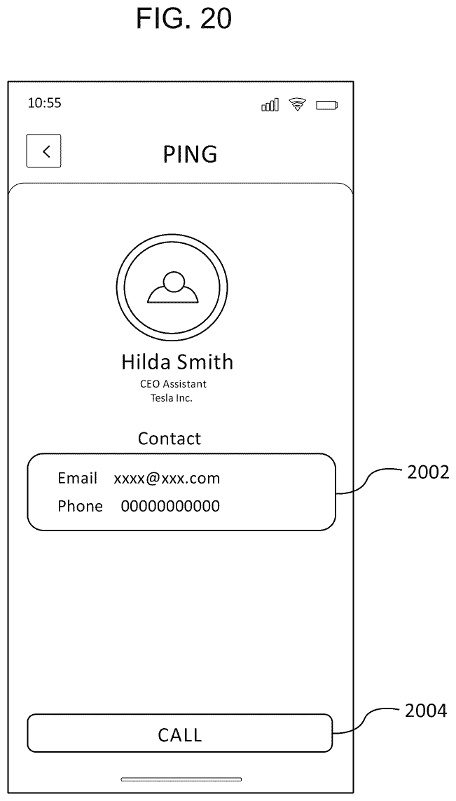

As aforementioned, a ping tag record includes optional alternate contact information such as mobile phone number and/or email address. This information, if present, can be used by visitor to place a mobile call or send an email message to the tag owner instead of placing an Internet call. While the information may seem redundant, they are useful as a backup in case the Internet is inaccessible on either side of the communication channel. A drawback of using alternate means of contact is, of course, the loss of video functions such as live preview video and video call. However, if there are any problems with the data call, the call screen will reverse back to alternate contact screen as depicted in FIG. 20, where the user has access to alternate contact, if configured, in order to reach the tag owner. At this screen, if the user taps on the phone number or email address (2002), the respective application will be automatically invoked for the user to conveniently place a mobile call or send a message instead. The CALL button (2004) is for the user to redial the data call.

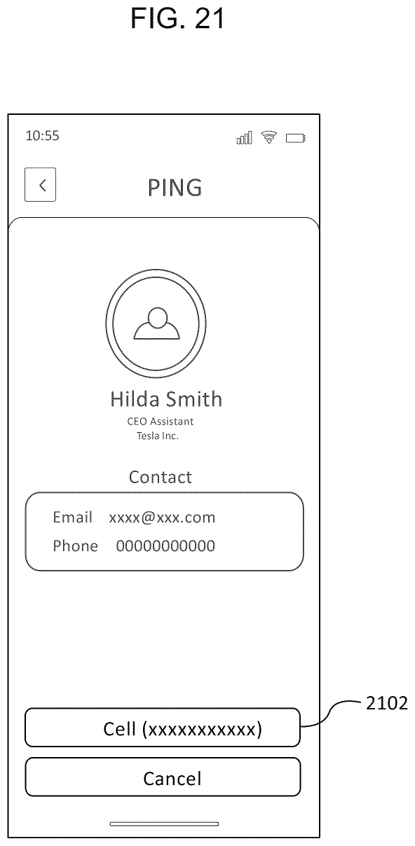

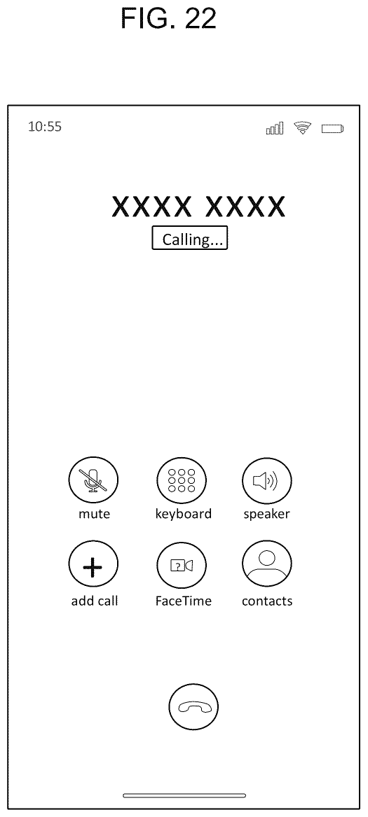

At the screen display, to place a mobile call, the user simply taps on the phone number. The action causes the app to retrieve the phone number and set up for placing a call through a series of API call made available by the phone OS vendors. For example, on iPhone, the app will use a CallKit framework made available by Apple for developer to setup receiving or placing a mobile call. Similar tool is also available for Android phone. In a user interaction scenario, the app responds to the phone-number-tapping action by showing a pullup menu for user to confirm the call as depicted in FIG. 21. Once the caller confirms the number to place the call (2102), the default phone app is invoked to place a mobile call to the given number as depicted in FIG. 22. Afterward, the user interacts with the phone app to complete the call. Once the call is hung up, the user can reverse back to the app as normally would. It is noted that mobile call is placed over VoIP system maintained by the mobile phone service provider and therefore, does not require Internet access. Those skilled in the art should readily recognize that other means of contact could be introduced as alternate contacts to further extend flexibility, such as popular social networks, e.g., LinkedIn, Instagram, Facebook, etc., and messaging platforms such as Snapchat, WhatsApp, etc. should both the caller and the tag owner are a regular mobile user of these platforms.

Thus, in another mode of operation, a call of the present invention does not necessarily always to be a data call or a preferred method of placing a call. It could be either data or mobile call as described. In some circumstances, mobile call could be a preferred method for placing a call such as when Internet is not accessible or when mobile call is a preferred method of placing a call to preserve traditional call user interface that most users are already familiar and comfortable with, while data call is optional and only be invoked on user's command. That is, the order of call-placing methods is reversed from the description above. Alternately, the app, or a mobile phone app incorporating the present invention, could present a call screen that prompts the user to select whether a mobile call, if a phone number is provided in the ping tag, or data call, if Internet is available, to place a call after the ping tag is successfully scanned. A phone operating system vendor such as Apple and Google, can easily detect whether the user's device has Internet access or not using internal development tools.

### 1.6. Multi-Sessions

In the event multiple incoming calls are placed from the same ping tag, the present invention will process and handle them in parallel through the use of call session id as described in a previous embodiment, provided that the tag was set up with multiple call recipients. In this case, depending on Ping Mode setting, an incoming call will either ring on all available call recipient(s)' device as aforementioned or hunt for an available call recipient for ringing while in-process calls are still going on. When an available call recipient picks up the call, the call is established as a new call session. Similarly, subsequent incoming calls can be established in parallel with in-progress call simply by repeating the same process, until the call recipient list is exhausted. In this case, the caller will receive a Busy signal. In another mode of operation, the incoming call will ring on all devices regardless of whether a device is in the midst of another call or not. In this case, the person on a call can temporarily put the in-progress call on-hold to accept the incoming call on another call session. Later, the call recipient can switch back and forth between the two call sessions. This mode of operation is a common practice in normal phone service. Those skilled in the art should recognize and be able to implement such a capability.

### 1.7. Message

In the event an incoming call is unanswered by a user of the app of the present invention, the present invention will allow the caller to leave a message to the user. The message can come in the form of a text, a voice or video message. Since message is associated with a call, the call session record must have space reserved for storing the text message itself or, in case the message is a voice or video message, a resource link (URL) to the location of the message where it would be stored. Typically, audio and video messages are stored as multi-media files in a mass storage system such as AWS S3 storage service. When a call is unanswered, the caller will be prompted whether s/he wants to leave a message and the type of message s/he wishes to leave on the call screen. The caller can choose leaving a message of one of the three message types as aforementioned. If a text message is selected, the app will prompt the caller to enter a text message. If voice message is selected, the app will prompt the caller to speak on the microphone for recording the caller's voice message. Similarly, if the caller selects to leave a video message, the app will prompt the caller to record a video message using the front camera and microphone of the device. Once the message input or recording is complete, the app will issue an API passing along the message content to the call service system for storing in association with the unanswered call session. Upon receiving request for storing the message and message content, the call service system will examine the message type in order to properly process the message content. For text message, the message will be stored in the call session record. For multi-mediate message, the media data will be uploaded to a storage system such as AWS S3 for storing and a resource link (URL) associated with it will be stored in the call session record. Once the message is properly stored and recorded as described, the call service system will notify the user of the app by both sending an email message to the user's registered email address and issuing a push notification message to the user's device. Both notification messages will contain linkage data to enable the user to open the message for viewing simply by tapping on the link or notification message. Those skilled in the art should readily know how to setup the app to collect a user's message using one of the discussed mechanisms, store it on the call service system and allow user's access to the stored message using the methods as described as these are well-known prior arts.

### 1.8. App-Less Setup

The app of the present invention was in effect hiding a tag owner's phone number from exposing to unknown callers by using Internet call instead of mobile call. The drawback to this setup is that the user has to download and install the app on their device for the Internet call to be made. A simpler setup could be presented when the call is made using mobile call instead of Internet call. In this case, a web app can be provided and accessible on the cloud network to allow the user to simply enter own phone number in association with the tag. The phone number could be that of the tag owner's mobile device or even a landline number. Thus, when the caller scans the tag to place a call, when the tag's CallMode is set to Mobile, the call service system will return to call recipient's phone number to the caller app. The call app then invokes the phone app on the caller's mobile device passing the phone number to it in order to place the call over the mobile network instead of an Internet call over data network. This setup has the advantage of being simpler and may be a preferred setup for most novice users but the drawback is, as stated, the user's phone number will be exposed to the caller.

Together, the optional settings are described above will transformed the ping record as below:
{
   CreateTimestamp,
   LastUpdateTimestamp,
   TagId, // Unique ping tag id
   UserId, // Tag owner—unique app user id
   TagType, // Entry, Pet, Asset, ID, Contact, . . .
   TagProfile {// Optional profile information
      ProfileImage,
      ProfileInfo, . . . // Vary on tag type
      Contact {// Optional alternate contact details
         Name,
         Address,
         PhoneNumber,
         Email,
         SocialNetworkIds // Twitter, Facebook, LinkedIn, . . .
      }
   }
   CallOptions {
      PreviewMode, // On or Off
      CallMode, // Audio, Video, Mobile
      PingMode, // 1-on-1, Conference, Hunt
      CallRecipients {// List of call recipients
         UserIds, // if CallMode is Audio/Video
         PhoneNumbers // if CallMode is Mobile
      }
   }
}

### 2. PingPad

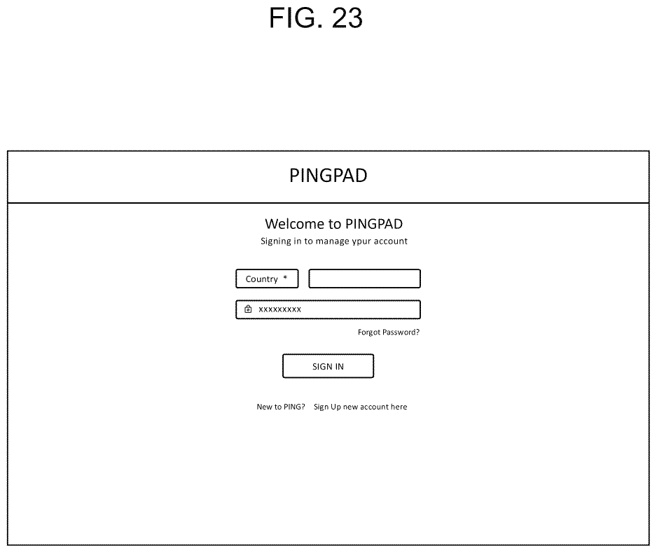

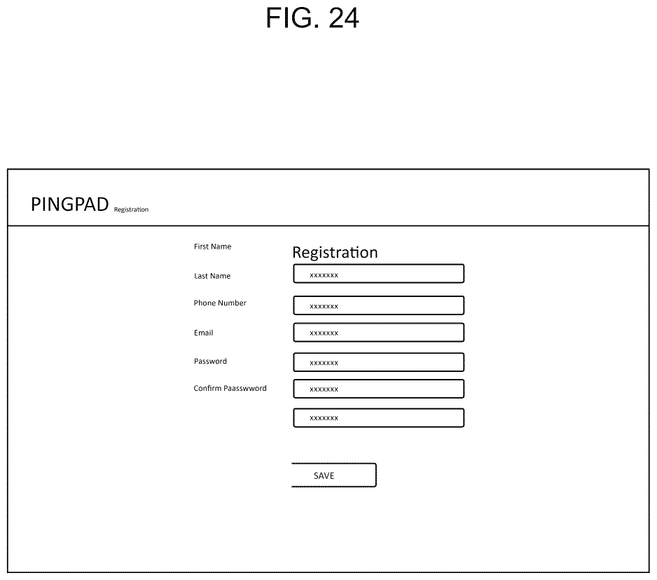

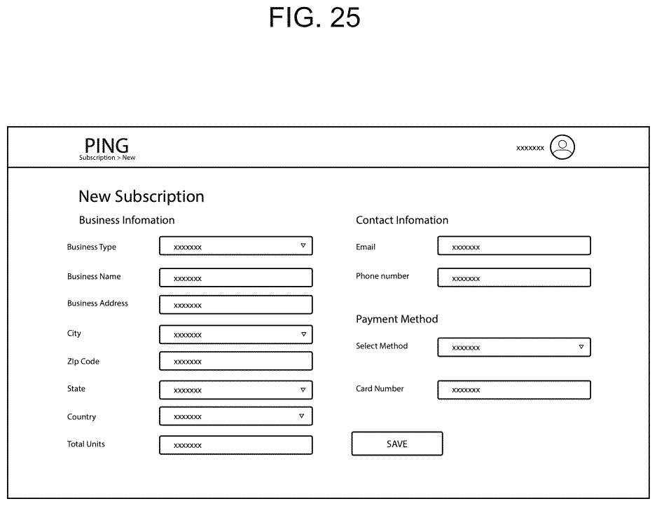

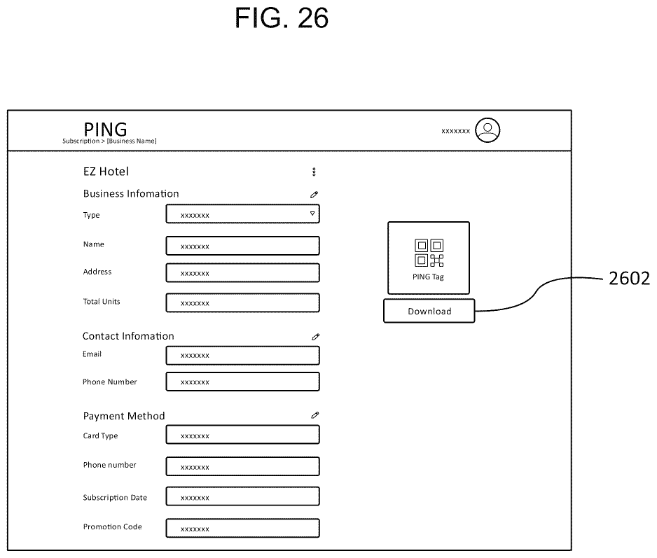

For entry tag, after a ping tag with QR code image is generated, the user can print it on paper and post it at the door entry where it is visible to visitors for scanning. While this method works fine for individual residential unit, in building complex with visiting lobby such as hotel, gated community, or office, it is desirable to have a way for visitors to place a call to a resident from the lobby or from security gate. Thus, in this embodiment, the present invention introduces a common or group ping tag, aka. PingPad tag, for living community and a system for routing visitor calls to a destined user's device in similar way as the telecom PBX system. That means every resident will be assigned a unique extension, or access code, that a visitor is required to enter to reach the intended resident or member of a business. The extension (or access code) could be of any reasonable length, e.g., 4 to 6 characters, of any printable char or numeric, alphanumeric or alphabet-only string. A new tag type, aka. PingPad, is introduced to provide support for access code-based call routing function. Access code (extension) can be as simple as a unit/room number. It could be a randomly-generated unique number or based on a scheme determined by the business administrator of a business. The access code of this embodiment serves as a call routing mechanism similar to landline phone extension. Similar to Entry tag, this tag profile also includes tag-posting location and an access code. To acquire such a ping tag, a business entity is required to register for service on SQUAREPING website as depicted in FIG. 23 to 24. After a successful registration, the user then logons to the system to subscribe for service. The user will be presented with a form for entering information on the business such as business type, name, address, contact information, payment information, etc. as depicted in FIG. 25. Additionally, the user also specifies the total number of units/rooms (or extensions) required by the business. This information will be later used for generating unclaimed per-unit ping tags that will later be claimed by end-users, i.e., call recipients, for receiving incoming calls from visitors. Once the subscription was properly setup, the user taps on the SAVE button to submit the subscription request to call service system through a REST API passing the user account id and business subscription profile information as aforementioned. Upon receiving the request, the call service system generates a unique group id and assigns it to the subscription profile before saving it to the group table of the call service database. The group id will be set as the owner of the subscription, while the user who creates the group profile will be set as the owner of the group record. An owner of a group, of course, assumes full administrative authority on a subscription such as editing business profile, cancelling the subscription, change payment method, etc. Refer to FIG. 26, once the user submits the subscription to the call service center, assuming that the provided information is valid, the subscription will be created in the group table. Next, the business administrator sets up an extension scheme for the business. For example, a hotel could use room number as extension code. Similarly, an apartment or condo could use unit number as extension code. Once an extension scheme is decided upon, the business administrator can generate a series of ping tags marked as ‘unclaimed’ for claiming by the residents of the business. To provide support for group subscription, the ping tag entry is extended to contain at least the additional settings highlighted in boldface:
{
   CreateTimestamp,
   LastUpdateTimestamp,
   TagId, // Unique tag id
   UserId, // Tag owner—unique user id
   TagType, // PingPad, Entry, Pet, Asset, ID, . . .
   GroupId, // Business (group) id
   Business Type, // Lodging, Residential, Office, . . .
   Extension, // Extension or access code
   Passcode, // Extension claim passcode
   Tag Profile {// Optional profile information
      Profile Image,
      Profile Info, . . . // Vary depending on business type
      Contact {// Optional alternate contact details
         Name, // Business name
         Address, // Business address
         Phone Number, // Business phone number
         Email, // Business email address
         Website // URL to Business website
      }
   },
   Call Options {
      Preview Mode, // On or Off
      Call Mode, // Audio, Video, Mobile
      Ping Mode, // 1-on-1, Conference, Hunt
      Call Recipients {// List of call recipients
         User IDS, // if CallMode is Audio/Video
         Phone Numbers // if CallMode is Mobile}
      }
   }
}

An unclaimed ping tag will have the User ID field of the ping tag will set to empty, the Group ID is set to the business (group) id, effectively assigning the business as the owner of the tag. For individual tag owner, this field is always set to empty. the TagType is set to PingPad and the Business Type field is set to the business type of the business profile. The Extension field will be set to a valid extension of the business call service for claiming by an assigned member of the business. For example, tag type Lodging is designated for temporary living space such as hotel, motel, hostel, etc., tag type Residential is designated for residential complex such as condo, apartment, townhome, gated community, mobile home park, etc., tag type Office is designated for business office in general. Finally, a PingPad QR code image could be generated from the subscription id. All other fields are set to empty for members of the business to set up with their own information and preferences. Once the PingPad tag image is successfully generated, the user can download (2602) the PingPad tag image for printing and posting at one or more desired location on the business premises. When a visitor scans the PingPad tag QR code image, the subscription id is retrieved for processing as described subsequently. It is noted that the subscription may have to go through a validation and verification process before it can be activated for use. During this time, the subscription will be suspended until explicitly approved by the system administrator either manually or automatically. This process may involve several manual and/or automated sub-processes for validating and/or verifying the provided information such as business entity, contact information, payment method, etc.

### 2.1. Ping Tag Claim Process

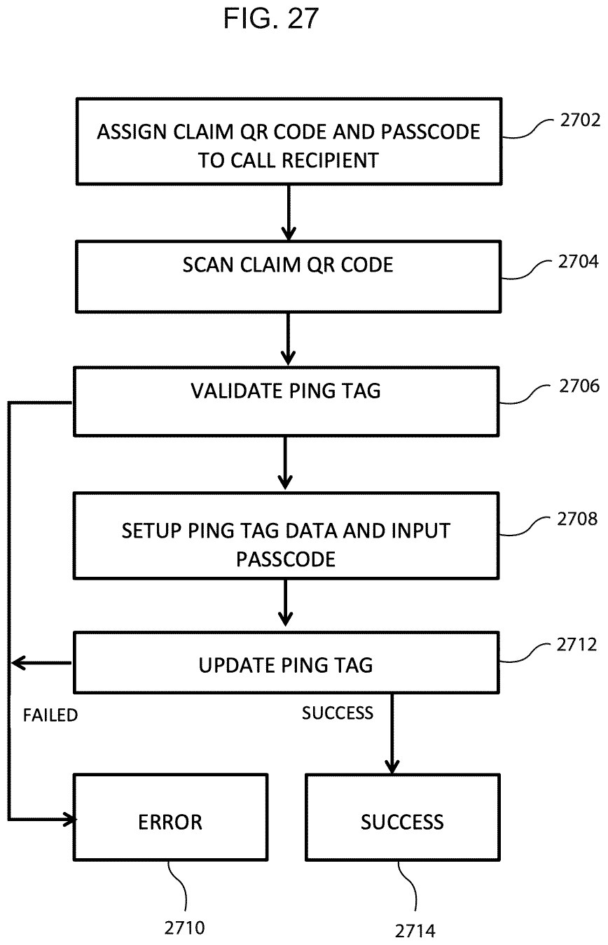

Before a member of a business, i.e. guests, residents, employees, etc., can receive incoming calls from the subscribed PingPad tag id, refer to FIG. 27, the call recipient of an extension must register as the owner of the extension using his/her mobile device. Thus, the business administrator must provide every member of the business a claim QR code image and a passcode (2702). The claim QR code image encodes an API call that can be used to retrieve the ping tag record associated with the access code (or extension) as given in the example below:
https://ping.squareping.com/claim/<ping-tag-id>

where the <ping-tag-id> identifies the ping tag record associated with an assigned access code. The passcode is used to confirm the identity of the claimer and thus, avoid fraudulent claim. The call recipient is required to install the app of the present invention on own mobile device and then uses the app to scan the claim QR code to start a claiming process that allows the user to setup a personal ping tag profile and associated call options. Once the user uses the app to scan this image, the encoded URL is retrieved and used to access the ping tag record from the call service system through an API call (2704). Upon receiving the request, the cal service system retrieves the ping tag record associated with the given ping tag id and, if the operation is successful, it validates whether the ping tag has already been claimed by someone else (2706). If ping tag has not been claimed, the call service system responds to the API call with a positive response and the unclaimed ping tag record to the app for claiming, i.e. setting up. Otherwise, it returns an appropriate error code to the app (2710). When the app receives the positive response from the call service system, it will proceed with prompting the user to set up the remaining unset information to claim the tag, i.e. tag profile, alternate contact information, call options and one or more call recipient (2708) as described in a previous embodiment. It is noted that the tag profile setup varies depending on various factors such as business type, tag setup policy administered by the business administrator, etc. For example, a business may want to include the business information on the tag profile, instead of that of individual member of the business, e.g., hotel. While another type of business may prefer the tag profile to reflect that of individual member of the business, e.g., an apartment. Once the call recipient finishes setting up the tag profile and call options, the app then prompts the user to enter the passcode before submitting the tag data and the passcode to the call service system using an API call for update (2712). If the provided data are valid. The call service system will set the User ID field of the ping tag to the requesting user id and finally updates the ping tag record in the database to complete the claiming process successfully (2714). Otherwise, it will return an error code to indicate the claiming process failure. The error code could be encoded to give information on the type of errors encountered. It is noted that the use of claim QR code to identify the unclaimed ping tag record is aimed to simplify the claiming process. Those skilled in the art should recognize that the same can be achieved by providing the call recipient the subscription group id and access code to identify the associated ping tag record. In this case, the call recipient is required to enter the subscription group id and access code to the app for it to retrieve the unclaimed ping tag record. It is also noted that a simpler setup without requiring the call recipient to install the app of the present invention is for the business administrator to associate a ping tag record with the phone number of a call recipient. This type of setup may be desirable for short-term lodging business such as hotel, motel, etc. where people check in and out frequently. In this case, the hotel receptionist can use an online form to enter a guest's phone number in association with an extension, e.g., room number where the guest stays. Visitor calls can later be established using mobile call procedure as described in a previous embodiment simply by entering the room number. When the guest checks out, the receptionist simply clears the phone number from the corresponding room number where they guest stayed to make it available for the next guest.

### 2.3. Call Handling Process

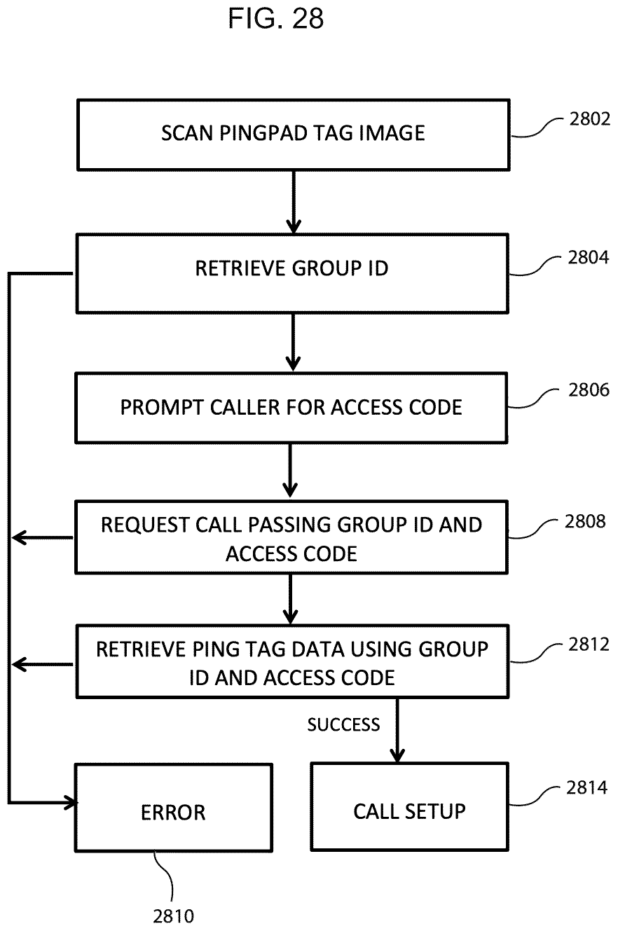

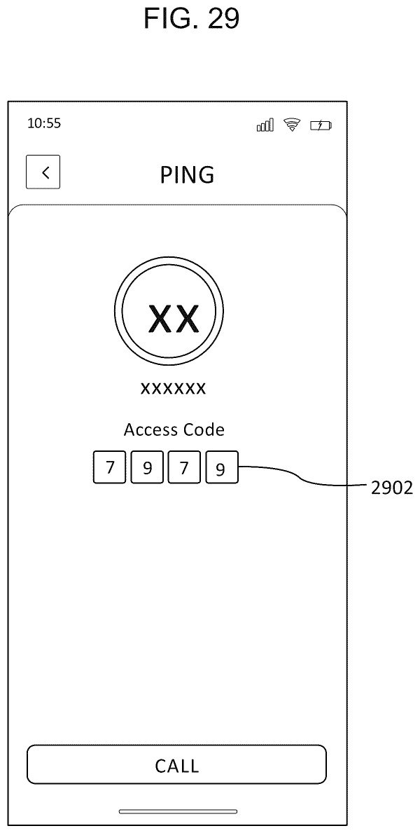

Refer to FIG. 28, when a visiting caller using the app of the present invention to scan the subscribed PingPad tag image (2802) posted, let's say, in the lobby of the business, the app will retrieve the PingPad tag id from the resulting URL (2004) and further prompt the user for an access code (2806). The prompt screen will display the tag profile of the business as depicted in FIG. 29. Once the caller enters the access code (2902), the app will issue a call request API to the call service system as described in a previous embodiment passing the PingPad tag id (or group id) and the access code as parameters (2808). When the call service system receives the request and associated parameters, it will use the given parameters to query the ping tag table for the requested ping tag setup. The operation will, of course, result in the personal ping tag setup that the call recipient created earlier as described above (2812). If the call recipient list is not empty, the call setup, routing and handling operations will occur as described in the previous embodiments (2814). Otherwise, if there is any error during the above process, the call service system will respond with an appropriate error code (2810). Optionally, upon receiving a positive response from call service system of a personal ping tag associated with the access code, the app could display the profile of the ping tag for the visitor to confirm the intended party actually before placing the call. A side benefit of this scheme is it also allow the visitor to have access to alternate contact information if given by the ping tag owner. This option could be available to the business administrator and/or the tag owner depending on the business' usage policy.

It is noted that the access code could be automatically assigned by the system among those have not been claimed in the system instead of a manual assignment process as described in this embodiment. That is once a call recipient acquires a ping tag as described in this embodiment, the app automatically selects an unused code by communicating with the call service system and then prompts the user for acceptance. At this point, the user could have an option to personalize the access code for easy memorization by entering another code of preference. If the new code does not match any existing access codes with the same tag id in the ping tag table, the system will accept and the user can proceed with other steps to setup the ping tag. Otherwise, the app will prompt the user to try another one. Such access code selection process is well-known prior art, those skilled in the art should know how to implement such process. It is also noted that this setup will allow for multiple incoming calls destined to the same extension to be processed and handled at the same time provided that end point device was set up with multiple call recipients. Furthermore, since the claimed ping tag is unique and personal, the call recipient can generate a ping tag image from the claimed ping tag for personal use. For example, it could be posted on the call recipient's door entry for visitors to place a call directly to the call recipient.

### 3.1. Unassigned (Pre-Printed) Ping Tag

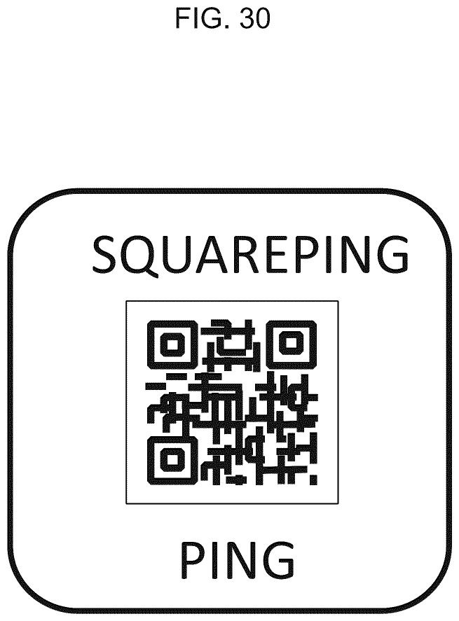

In another embodiment, the present invention allows the user to claim a pre-printed unassigned ping tag. This process will help to relieve the users from the trouble of printing ping tag as ping tags could be economically pre-printed by professional printing shop in bulk and in long-lasting materials for order by end-users. In this case, large bulk of unassigned ping tags will be generated ahead of time. Each of the unassigned ping tags will be assigned a unique ping tag id with the tag type set to UNASSIGNED and all other fields are left empty. The generated ping tags are then stored in the ping tag table ready to be claimed by app users at a later time. The ping tag id (of the unassigned ping tag) is then used to generate a corresponding QR code image as depicted in FIG. 30 for printing and distribution. As a reminder, the QR code image represents a URL of the below format as described in a previous embodiment.
https://ping.squareping.com/ping/<ping-tag-id>

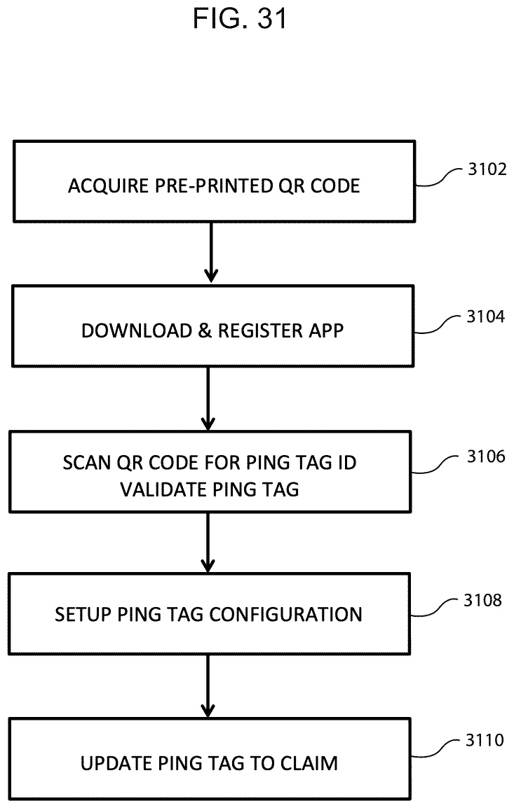

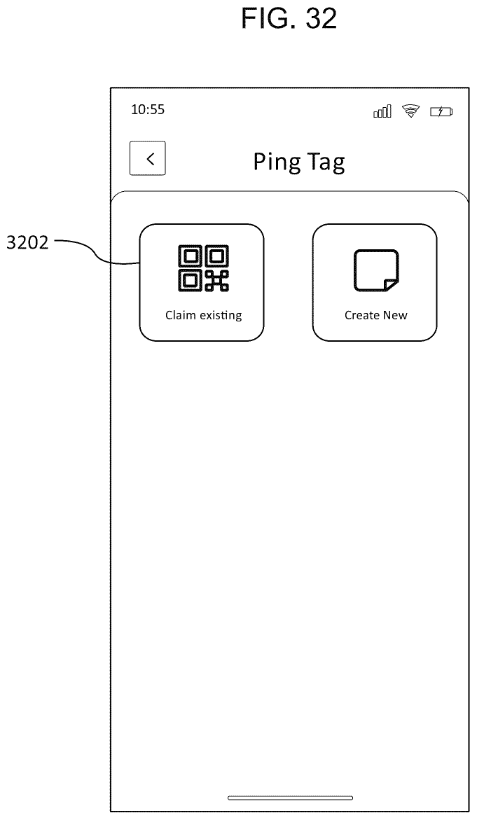

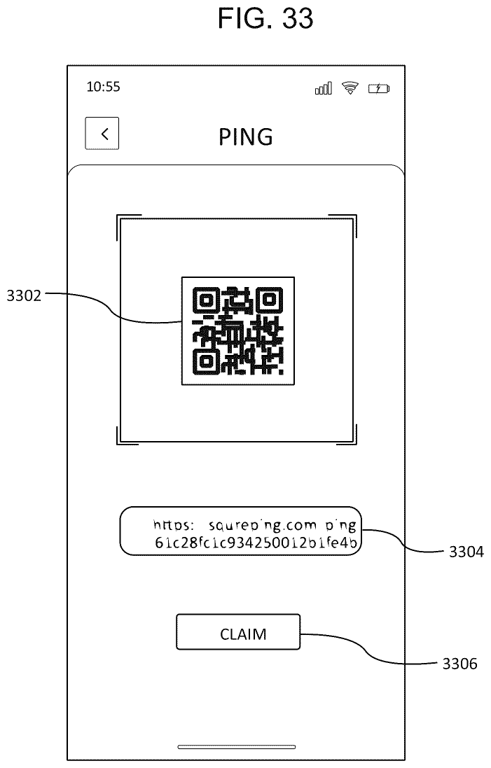

Now, refer to FIG. 31, which describes the process for claiming an unassigned ping tag. After a user acquires an unassigned ping tag label (3102), the user must first download and register the app and then use the app to claim the ping tag before it can be put in use. Once the app is installed and registered (3104), the user can use the app to claim an unassigned ping tag. First, the user uses the app to scan the QR code of the ping tag and parse the resulting URL for the ping tag id (3106). Next, the app issues a ClaimPingTag API passing the retrieved ping tag id to the call service system to verify whether the ping tag exists in the system and unclaimed. Upon receiving this request, the call service system will query the ping tag table for the ping tag specified by the given ping tag id. If the tag exists and the type of the tag is UNASSIGNED, the call service system will respond to the app with a positive response. Otherwise, it will respond with an appropriate error code. Assuming that the app receives a positive response from the call service system, it then proceeds with prompting the user for setting up the tag as described in a previous embodiment (3108). As a result of this setup, the tag type is updated to reflect user-selected tag type. Once the user completes the setup, the app issues an UpdatePingTag API to the call service system in order to save the tag to the ping tag table, passing along the ping tag id and complete user's setup data (3110). If this operation is successful, the ping tag is ready for use. FIG. 32 to 33 demonstrate an example of the claiming process as implemented by SQUAREPING app. First, refer to FIG. 32, the user taps on the Claim Existing button (3202) to start the QR code scanning process. Then, on the QR code scan screen, refer to FIG. 33, the user positions the back camera of the user's mobile device on the unassigned ping tag (3302). Upon detecting and successful reading of the QR code, the app retrieves and displays the decoded URL (3304) on the screen as shown on the screen. At the same time, it scans the URL to retrieve the ping tag id. When the user taps on the CLAIM button (3306), the user will be prompted to select a tag type, followed by setting tag profile, call settings and selecting call recipients as described in previous embodiment. Once the user saves the ping tag to the ping tag table, it will carry the original tag id, but all settings are properly set by the user to his/her desired settings. Thus, the ping tag is claimed by the user. After a successful claiming process, the tag can be put in use as previously described. The call processing is exactly the same as described in previous embodiments. It is noted that, using this claiming process, any ping tag can be reclaimed (or reconfigured) provided that its tag type must be reset to UNASSIGNED, while the ping tag id remains the same. Such reclaiming process is useful in certain application settings such as motel, where guests come and go frequently, but the entry ping tags assigned to motel rooms stay the same.

3.2. Pre-Printed Ping Tag with Access Code

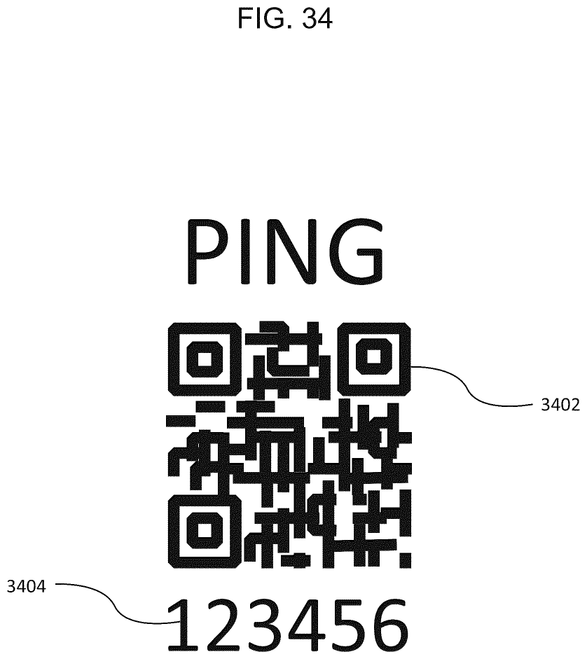

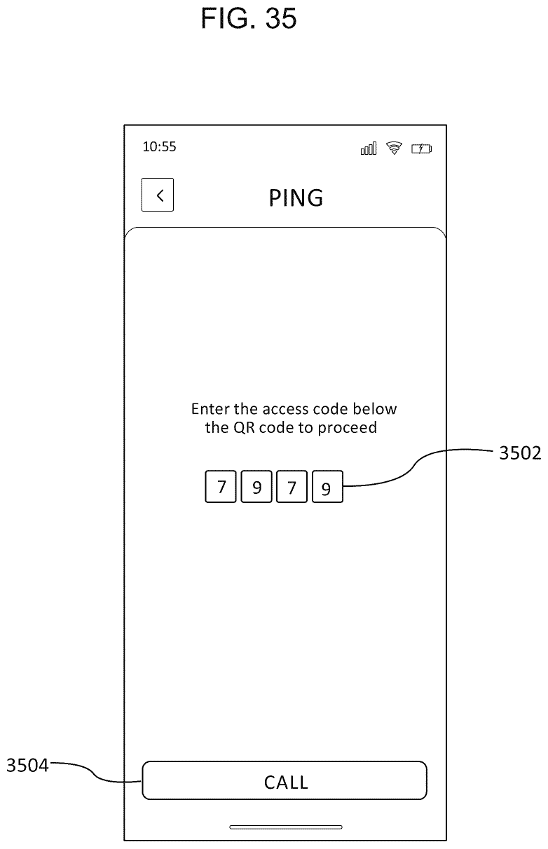

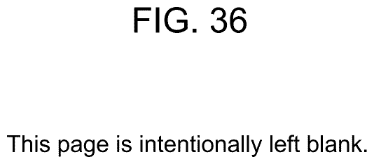

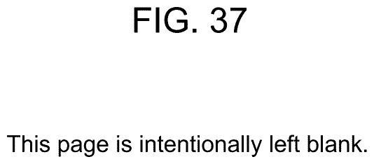

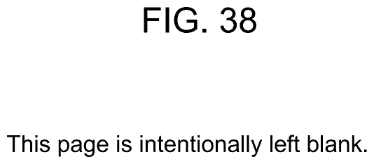

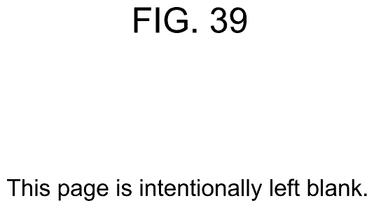

However, printing a unique QR code for every ping tag label in bulk as previously described may not be doable as many print shops are not equipped to do such printing in automated manner. Thus, this embodiment of the present invention introduces the use of a human-readable unique access code in combination with a common QR code in order to differentiate one ping tag from another as depicted in FIG. 34. Since the QR code is now the same for every ping tag in print, it would overcome the limitation of many print shops. However, in order for the system to differentiate one ping tag of this embodiment from the others of the same QR code, a unique access code will be introduced and printed along with the common QR code on every ping tag label as depicted FIG. 34. The QR code (3402) is the same for every ping tag of this embodiment, but the access code (3404) is different from for every ping tag in print carrying the same QR code. Printing such a ping tag is much more cost-effective as the access code could be programmed to be consecutively increasing for subsequent ping tag labels. As given in the example, the access code is a decimal number of 6 decimal digits. This allows up to around one million ping tags to be printed in bulk using the same QR code. The access code could be of any reasonable length, e.g., 4 to 6 characters, of any printable character or numeric, alphanumeric or alphabet-only string. The common QR code itself is, of course, associated with a ping tag of which ID is used to generate the QR code as previously described. This ping tag of this QR code, aka. master ping tag, must be created in the system as a place holder with all fields except for the ping tag id are set to default value or left empty. The access code would be set to all zeros to indicate that it is a master ping tag. It is noted that this process requires only the master ping tag to be initially created for printing, while the rest will be created on demand as users are claiming the printed label they receive at a later time. Later, a user who acquires a ping tag label of this embodiment must use the app of the present invention to go through a ping tag claiming process. This process involves scanning the label, validating it as an unclaimed ping tag with the system and then creating a ping tag associated with it. The app of this embodiment must be able to use the device camera to scan the print label and detect both the QR code for the ping tag id and the access code on it. Those skilled in the art should readily recognize that the app scanner could be implemented perform such function as libraries for number recognition are available from a variety of developer community. It is important to automate this process through the scanner in order to prevent user from mistyping a wrong access code that could result in claiming a wrong unclaimed ping tag. Once both the ping tag id and access code are identified, the app uses the ping tag id and the access code as a key pair to validate with the system that it has not been claimed by any users and, if so, continues to interact with the user in order to complete the ping tag setup as described in a previous embodiment. Once the setup is complete, the app interacts with the call service system to create a new ping tag with the ping tag id and the access code of the ping tag are set to those retrieved from the ping tag label. Other setup data are set in accordance to user's input. The ping tag id and access code pair will later be used by the system to locate the ping tag setup for routing incoming calls to the user as described in a previous embodiment. When a visitor scans the tag label using the default camera app of his/her mobile device, only the QR code is recognized. However, when the resulting URL is tapped on by the visitor, the app will be invoked and it will learn from the call service system that the ping tag id is not unique. As a result of this discovery, the app will prompt the user for access code as depicted in FIG. 35. Alternately, instead of prompting the visitor to enter the access code, it could also prompt the visitor to position the back camera of the device to scan the tag again using the app scanner, which is capable of retrieving the access code from the label automatically. Either way, once the access code is entered (3502), the app then enables the call button (3504) for the visitor to place the call as described in a previous embodiment.

### 4. Ping Doorbell

The description of this section was canceled and removed.

### 5. Baggage Recovery System

The description of this section was canceled and removed.

### 6. Call Group

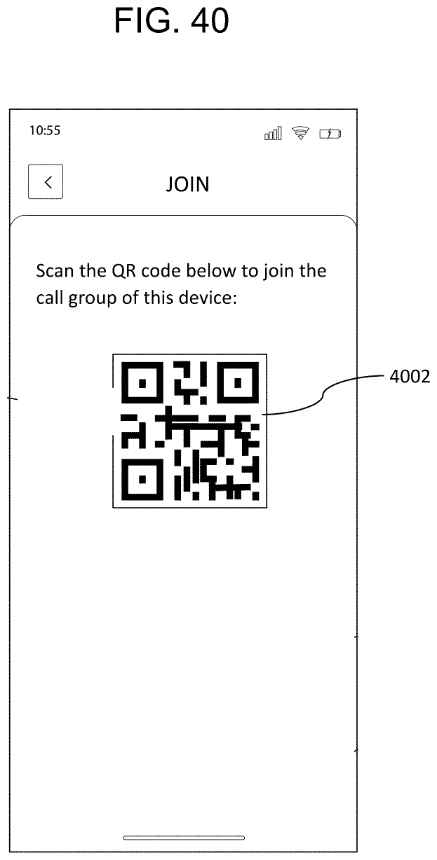

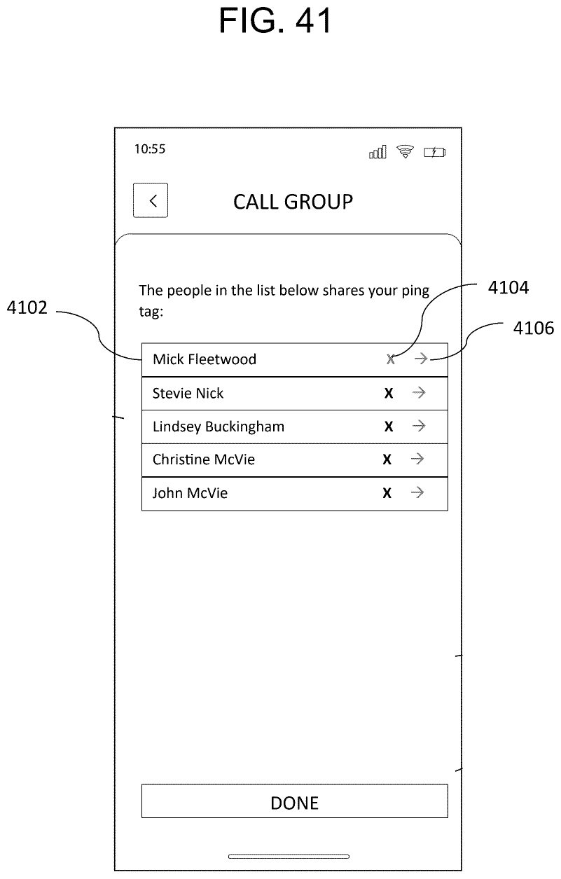

In another embodiment, the present invention further provides support for call group, i.e. a group of registered devices with the app installed. In this scenario, an incoming call from a ping tag associated with a device is automatically broadcasted to all member devices of the group for pickup. Such feature is very useful in certain scenarios such as in a household or work group with several members. There are a number of ways to form such a call group. However, in an arrangement, a device of the present invention will be assigned a group owner role for other devices to join as member. In this arrangement, the ping tag of the owner device will become a call group ping tag, i.e. a ping tag associated with a call group. In addition, the present invention introduces an intuitive method for dynamically forming a call group with minimal administrative effort. By default, a unique JOIN code is automatically generated for every registered device at registration time. Member devices have to read the code to obtain an id encoded by this code when they want to join a respective device who owns the code. Such code could be in the form of a QR code (4002) as depicted in FIG. 40, or it could be any code that is readable by a mobile device such as a plain alphanumeric string, bar code or RFID tag. In QR code form, the join code encodes an API call that executes the join operation on the call server and a device join code as given in the example below:
https://ping.squareping.com/join/<join-id>

where <join-id-> could be the device owner's user id or the ping tag id of his/her device. The JOIN code could also be in other form such as a plain alphanumeric string, bar code or RFID tag. However, such forms will not be capable of encoding the URL; thus, the app must provide the web API call to execute the join operation. FIG. 41 illustrates a list of call group members as a result of such join operation. Such list will be displayed on all member devices so all members are fully aware of those participating in the call group. On this list, a member, except the call group tag owner (4102), could leave the group any time using the arrow button (4106) on the right of his own entry. The owner of the call tag associated with the call group can remove any members at any time in the list using the X button (4104) on the right of every member entry. Note that the buttons are enabled only if they can be applied by the user of the listing device and automatically disabled, i.e. grayed out, if they are not as depicted in the drawing. In term of operations, a call coming in from a call group tag will be processed by the call server in accordance to ping mode setting as described in a previous embodiment, i.e. one-on-one, conference or hunt. By default, this call mode setting is set to ‘one-on-one’. However, using the app, the tag owner can alter this setting to one of the supported mode of operations. Those skilled in the art should also recognize that support such call group operations can easily be done for PingPad Intercom application, simply by replacing the call group ping tag in discussion with an extension.

### 7. Face Recognition

In another embodiment, the present invention further introduces an automatic face recognition process in order to determine whether a call placed by a caller is allowed to proceed. This process will improve black list processing as described in a previous embodiment in case the caller does not have the app of the present invention installed. In this case, a web browser on the user's device is invoked to execute the web app of the present invention to place the call using a temporary user id of which lifetime is limited; thus, blacklisting based on such caller's temporary user id does not have a permanent effect. A face recognition solution, on the other hand, does not require user's id. Instead, it relies on facial characteristics of the caller for determination on whether a caller is black-listed or not. Technology for implementing such process is well-known prior art and widely used for user authentication in many existing applications. In this embodiment, the blacklist record as previously described is expanded to additionally store facial characteristics of the caller for use in matching by a face matching algorithm executed on the call server. Thus, both user id and facial characteristics can be combined for performing such call qualification determination, depending on the availability of the concern data sets. This will allow the present invention to deal in a wider range of use cases to result in a higher rate of effectiveness. For example, when permanent caller's user id is not available as described above, face analysis data set will be used for looking up the blacklist. Otherwise, user id will be used for looking up the blacklist for optimal performance. Since face recognition requires an image of the caller's face for facial analysis, the app of the present invention on the caller's device must use the front camera of the caller's device for detecting and capturing an image of the caller's face. Once a face image is captured, a face analysis algorithm will be activated to analyze the image and gather a set of facial characteristics based on such analysis. The data set is then sent to the call server together with user caller's user id, if available, for storing in response to a block call action or matching against the blacklist in response to a call request event. In the latter case, if a match is detected by the matching algorithm executing on the call server, the call request will be immediately rejected without the callee's knowledge. Otherwise, the call request will proceed as described in a previous embodiment. Since face recognition technology is a well-known prior art as previously mentioned, those skilled in the art should be able to construct a face analysis algorithm to collect a relevant set of facial characteristics data and store the data set in a corresponding black list entry when a callee decides to block a caller from future calling as well as implementing a matching algorithm based on such data set against the black list.

### Additional Embodiments (New Matters Added in this CIP)

### 8. Policy-Driven Call Acceptance

In certain embodiments, call admission decisions may be governed by configurable policies, rules, or evaluation logic executed by one or more processing systems. The present invention further introduces a pre-acceptance policy control engine wherein various call acceptance policy controls are examined prior to progression of a session establishment sequence. These controls determine whether a call request is expedited, rejected, or subjected to a visual caller identification process before allocation of communication resources. Controls may include data automatically collected during call initiation, such as a caller's user identifier, facial characteristics as described in a previous embodiment, trust classification of the caller, historical blocking status, or subscription-level configuration settings defined by either the callee or the subscription administrator.

In certain embodiments, the policy control engine operates at a signaling control layer of the communication system and evaluates call admission criteria before signaling messages are transmitted to establish a communication session with the callee device. The policy control engine is executed on a network server, including but not limited to the call service server, and has access to backend databases including blacklist records and subscription configuration data. The policy control engine generates a call control signal indicating one of multiple call progression states, including rejection, expedited signaling, or preview-required signaling, which is returned to the call server for modifying session establishment behavior. Call signaling may be SIP, WebRTC, proprietary protocol, etc.

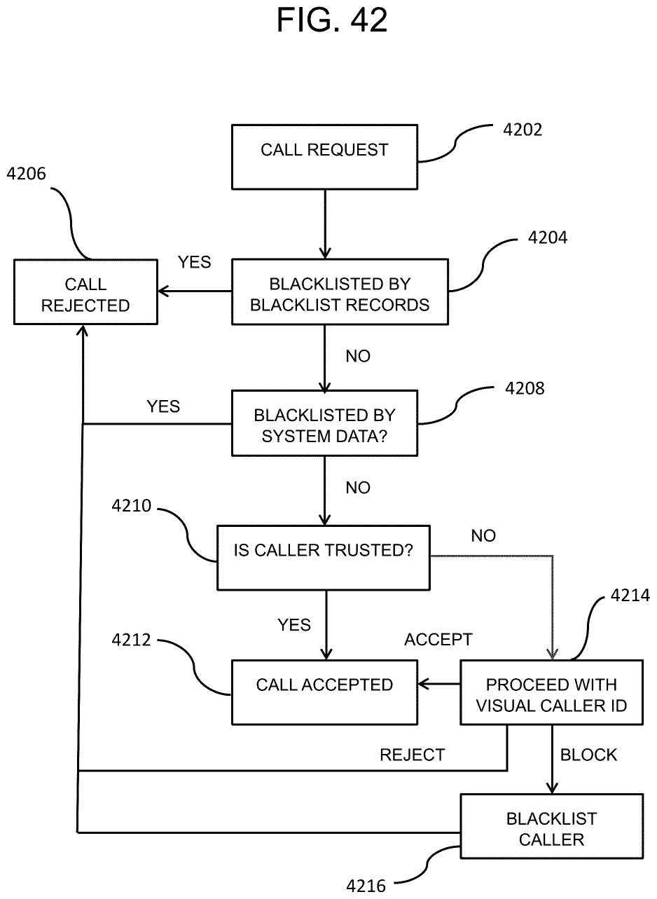

When a caller places a call, the caller device may activate a camera to capture image data for facial analysis. The caller device initiates a call request signal directed to the call service server, the call request signal comprising caller identification data including caller identifier and/or facial characteristic data. Refer to FIG. 42, upon receiving the call request signal, and prior to allocation of signaling or media channel resources for establishing a real-time communication session, the call service server forwards the call request and associated caller identification data to the policy control engine for evaluation. The policy control engine validates the received data and evaluates multiple independent call admission criteria. These criteria may include:
Per-recipient blacklist records (4204), which includes user's id, temporary id and facial characteristics data, if any;
System-wide historical blocking threshold data (4208), which is a configurable threshold number of block events may be stored in the backend database and evaluated by the policy engine as described in a previous embodiment;
Subscription-level policy configuration (4210); and
Trust classification data associated with the caller (4212) as described earlier.

If evaluation determines that the caller has previously been blacklisted or meets a rejection threshold, the policy control engine generates a call control signal instructing the call service server to terminate the call initiation request (4206). In such case, signaling progression toward the callee device is suppressed and no communication resources are allocated for session establishment.

If no automatic rejection condition is met, the policy control engine may determine whether subscription-level configuration permits trusted callers to bypass the visual caller identification process. If the caller satisfies trust classification criteria, the policy control engine generates a control signal instructing the call service server to proceed directly with signaling establishment without insertion of a preview state (4212). Otherwise, the policy control engine generates a control signal requiring insertion of a visual caller identification state into the signaling sequence prior to session establishment (4214). In this state, a live video stream is transmitted from the caller device to the callee device for preview prior to call acceptance. It is noted that the preview state occurs prior to full call session establishment. Only upon callee approval does the call service server proceed to establish audio and/or video media channels between the devices. Media channel allocation is gated by signaling progression. In this state, the callee can decide either accept or reject the call after previewing the caller's video, or to block the caller (4216). If the latter is selected, the caller's id, including facial characteristics, will be imported into the blacklist on the server system and the call is terminated.

Accordingly, the policy control engine modifies signaling state transitions of a session establishment protocol before media channel allocation. Depending on the generated control signal, the system may suppress signaling messages, alter signaling progression, insert intermediate preview states, or proceed directly to communication session establishment. This signaling-layer control enables the system to conserve network resources, prevent malicious call attempts, and expedite trusted communications while maintaining privacy and security protections.

### 8. PingPad Callboard

In a previous embodiment, referred to as PingPad, a QR code was configured to enable visitors to place calls to an extension associated with a member of a community served by the PingPad service. A unique QR code is issued for each community and displayed on a physical call board positioned in a highly visible location, such as a lobby or building entrance, so that visitors can easily locate it. To initiate a call, a visitor uses the call placement method of the present invention and enters the extension number associated with a desired individual when prompted. However, when a visitor does not possess a smartphone or when the visitor's smartphone is unable to place the call (for example, due to poor personal device's network connectivity), the visitor would otherwise have no means of contacting the intended individual.

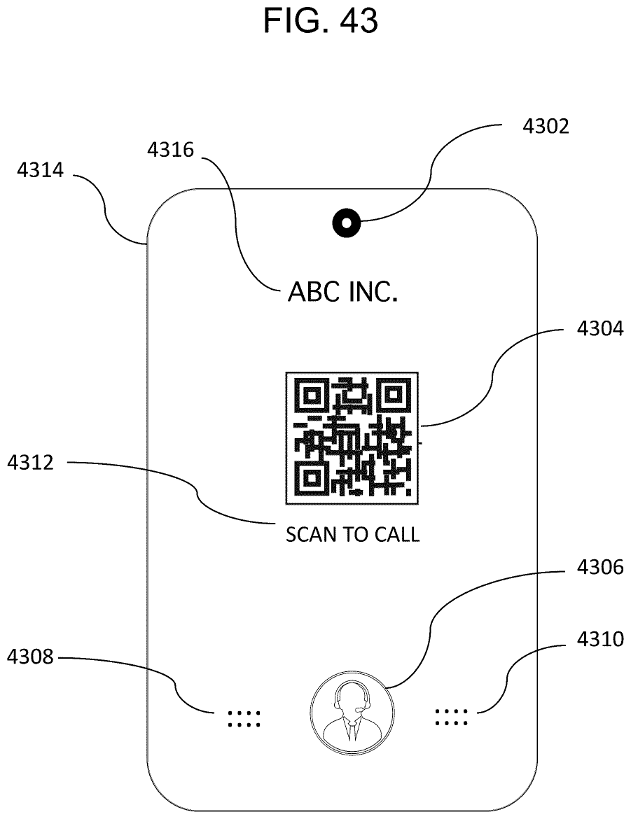

Accordingly, in another embodiment, refer to FIG. 43, the present invention extends to an electronic device serving as a visitor call board (4314). The device includes an Attendant button (4306) that allows a visitor to initiate a call to an attendant or operator directly from the device. Once connected, the attendant can forward the call to a requested extension in the same manner as standard internal transfers. The attendant may be a live human operator or an automated AI system. In the case of an automated system, the attendant may prompt the visitor to enter an extension number or, if unknown, provide a name for directory lookup. After confirmation of the requested destination, the system dials the corresponding extension and transfers the call, passing control of the device's microphone and speaker to the established call session. The call board device includes a Wi-Fi module enabling network connectivity through an on-premises Internet router, a microphone (4308) and speaker (4310) to facilitate two-way communication, and optionally, a camera to provide the attendant with a live view of the visitor prior to answering. In some implementations, the camera may also provide continuous live video of the surrounding area for monitoring purposes, viewable by security personnel via a remote display or mobile device. The QR code and an instructional phrase (4312) may be printed directly on the call board during manufacture. The specific wording of the instructional phrase can be customized by the business owner. Devices of this type, such as smart doorbells, are widely available, and the construction of such hardware is considered well known in the art. Similarly, call signaling for initiating, transferring, and managing sessions follows conventional telecommunication practices previously described in earlier embodiments.

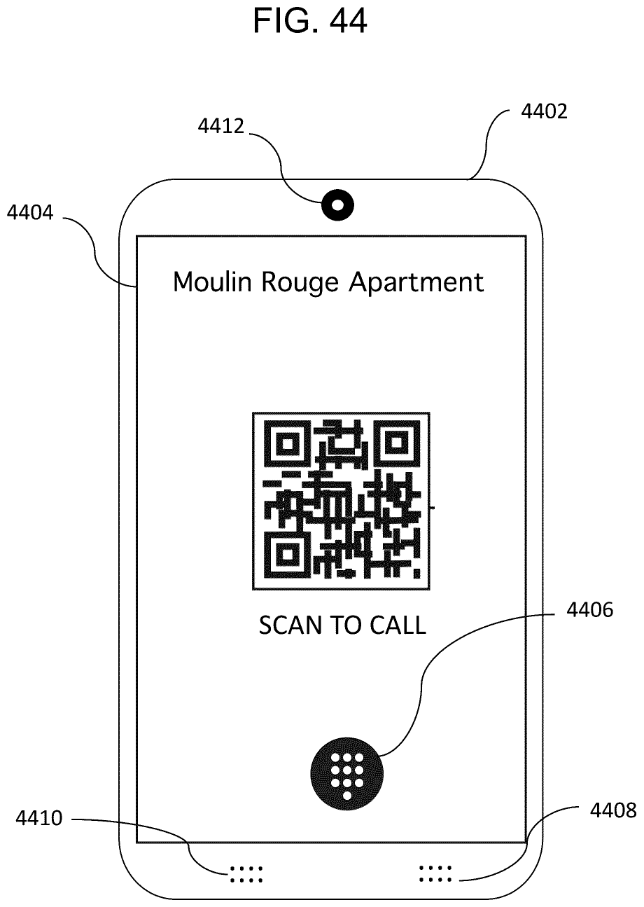

Referring now to FIG. 44, when support for a video call between a visitor and user is desirable, a network device such as a tablet (4402) can be used as the call board instead. Utilizing the tablet's computing and networking capabilities, as well as its wide-screen display (4404), a dedicated application may render the user interface components and allow the visitor to place a call directly to a desired individual—by name or by extension—without assistance from an attendant. The visitor interacts with the tablet by selecting a dial button (4406), which triggers the display of a dialpad interface. The visitor may then either perform directory lookup to search for an individual by name or enter an extension number to initiate a call. The microphone (4410) and speaker (4308) of the network tablet are available for call support. Depending on system configuration, the call session may be an audio or video call, as most network tablets are equipped with a front camera (4412) suitable for video conferencing. In either case, the visual caller id process will be applied to allow the call recipient to verify the identity of the caller prior to call acceptance as described in previous embodiment. When the call is ended, the screen automatically returns to its initial state, ready for the next visitor. In addition to enabling direct call placement, the network tablet can provide several enhanced features, including continuous security monitoring through the front camera when not in call session, automatic QR code online updates, facial recognition for identifying blacklisted visitors, and, if properly equipped with a cellular SIM card, cellular network connectivity when Wi-Fi access is unavailable. Although, the user interface was kept simple for the purpose of description, those skilled in the art should easily recognize that other user interface component can easily be added to the user interface to provide extra capability for visitors, e.g. adding an Operator button to allow visitor to call an attendant for assistance in special situations, a Security button for visitor to call security personnel in case of emergency, etc.

### 9. PingPad Service Management System

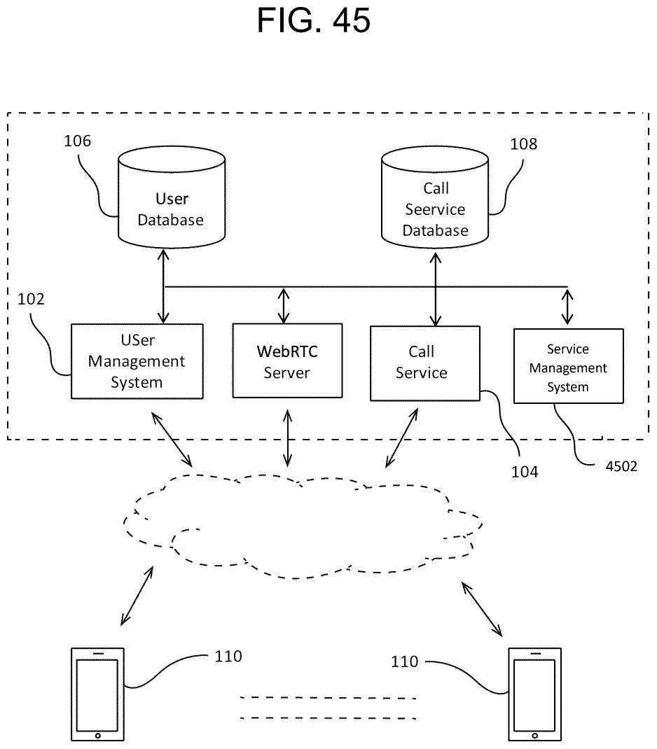

As illustrated in FIG. 45, the PingPad Service Management System (4502) is integrated with the call service infrastructure and operates as a configuration control layer for governing behavior of the communication network and operates as a provisioning control layer governing runtime signaling behavior of the system. The service management system interfaces with backend databases and the call service system to store, retrieve, and distribute configuration parameters that directly influence call routing, call admission decisions, signaling progression, and media channel establishment. Unlike a standalone administrative portal, the PingPad Service Management System functions as a policy provisioning subsystem that dynamically configures runtime communication behavior across multiple community subscriptions.

The setup process enables organizational customers to define operational parameters that are stored in backend databases and later retrieved by the call service system and mobile applications. These parameters include communication policies, extension routing rules, trust classifications, service grouping logic, directory visibility settings, and alert behavior definitions. Upon modification of configuration parameters by an authorized administrator, the updated parameters are propagated to the call service system, where they are applied during real-time evaluation of call admission and routing logic. Thus, the service management system operates not merely as a record-keeping interface but as a control-plane component influencing data-plane communication behavior.

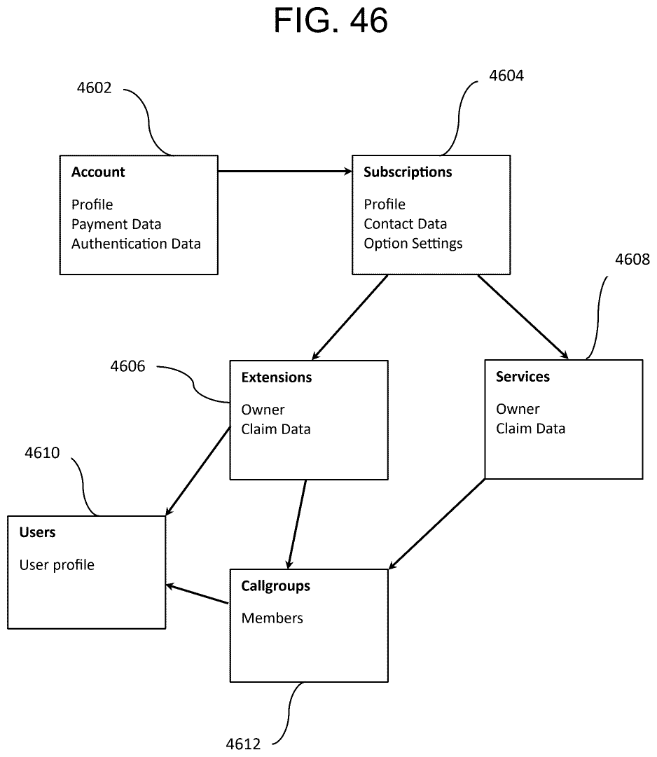

Refer to FIG. 46, Refer to FIG. 46, the system includes a plurality of structured data tables forming a communication control database architecture. The database architecture supports real-time communication control by storing:
Account-level identifiers used to segregate signaling domains,
Subscription configuration records defining call admission and routing parameters,
Extension records linking user identifiers to call routing endpoints,
Service group records defining multi-device call distribution,
Policy configuration records defining call admission criteria,
Call log records storing signaling and media session metadata.

The stored data is accessible by the policy control engine and call routing modules to influence session establishment, signaling sequence modification, and selective media allocation.

### 9.1. Service Accounts

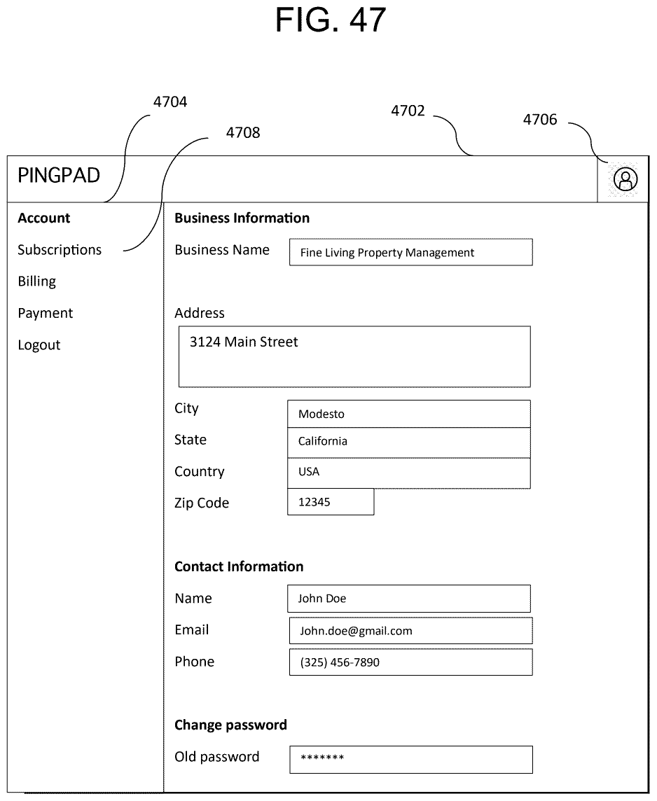

After a business customer opens an account and registers business profile as shown in FIG. 47. The account home page (4702) provides access to several administrative functions in the left panel (4704). These functions include:
subscription management—create and manage service subscriptions
and other support functions such as Billing and Payment.

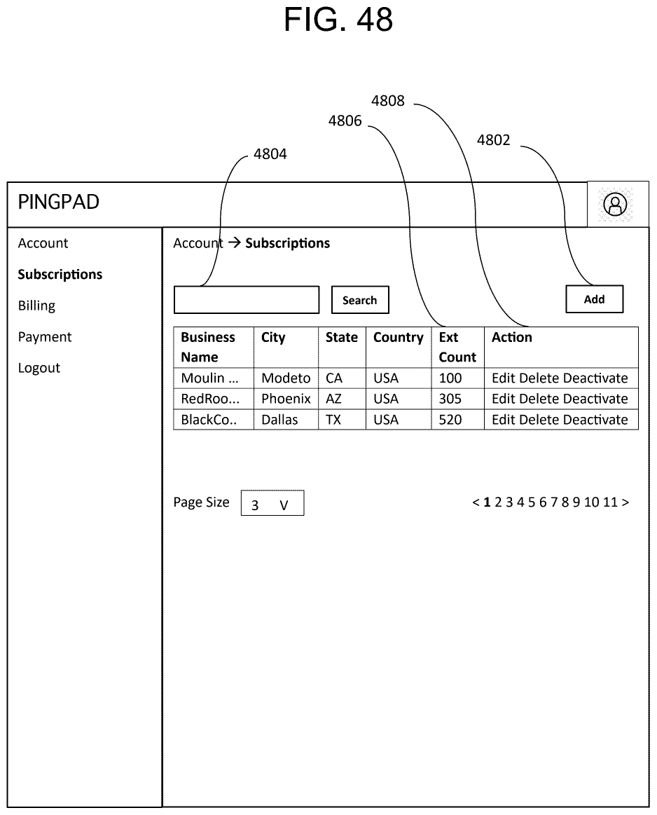

The top-right image area (4706) displays the avatar of the account user, typically the account owner or administrator. Click on this image will pop up a menu where the user can edit business profile and change authentication password. After an account is successfully created, the account administrators can proceed to create one or more subscription, each subscription associates with a property (or site). Using the Subscriptions menu item (4708), the administrator may access the subscription management page as shown in FIG. 48. This page displays a list of subscriptions created for various community sites. Each subscription represents a specific site, such as a hotel branch, office building, or managed property.

Refer to FIG. 48, the system allows the account administrator to create multiple subscriptions, each representing a property or site, under a single account. This arrangement allows a business, e.g. hotel chain, to subscribe and manage PingPad service for branch offices at different geographical locations. The Add button (4802) allows the account administrator to add a new subscription.

### 9.2. Subscriptions

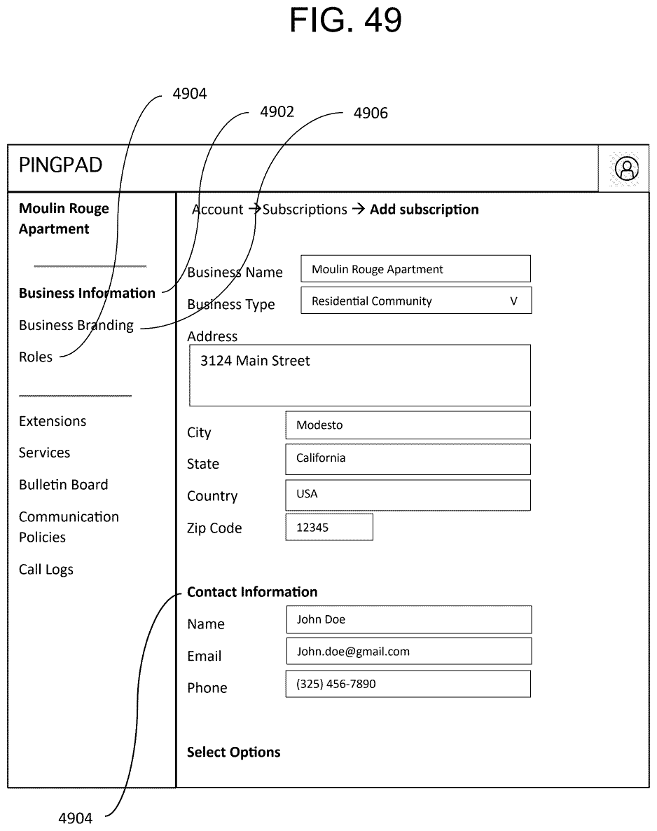

Refer to FIG. 49, when a new subscription is added to the account, the account administrator has the opportunity to register the subscription profile (4902), which includes business name, business type, business location information, contact information, and assign a subscription administrator to manage the subscription. PingPad system supports four business types:
Living communities, such as apartment complexes, condominiums, or mobile home parks;
Lodging businesses, such as hotels, motels, or short-term rental business; and
Business offices, including commercial, hospitals, schools, government institutions, and
Remote/Mobile businesses such as remote team, transportation, delivery, on-call services, etc.

The subscription administrator is responsible for managing the subscription. However, s/he can delegate whole or part of management role to others using the Roles menu item (4904), which provides facilities for the subscription administrator to assign team members for managing specific features of the subscription, i.e. extensions, services, bulletin board, . . . By default, the account administrator will assume the role of the subscription administrator. However, for large account deployment, the account administrator may want to delegate the subscription management role to other team members; practically, someone who work on site where the subscribed business located.

Back to FIG. 48, once a subscription is successfully added, it will be displayed as an entry in a subscription table on the Account home page. The Ext. Count column (4806) shows the number of extensions allocated to corresponding subscription entry. The search box (4804) supports quick lookup of a subscriptions by name, address, state or country, and the Action column (4808) provides functions to edit, delete, or deactivate associated subscription.

### 9.2.1 Business Branding

Back to FIG. 49, in another embodiment, PINGPAD app allows customers to co-brand on the app as a customer benefit. Using this feature, accessible through Business Branding menu item (4906), PINGPAD customers will have an opportunity to extend user's engagement through PINGPAD app, thus, help to improve user's loyalty. The Business Branding menu item of the subscription management page allows subscription administrator to upload own business banner image, logo image, and slogan for display within the PingPad mobile app. These branding elements appear prominently on the app's Home screen, call notifications, various call-related screens and even notification messages, giving users a feel of interacting with the business rather with PINGPAD system. If no branding data is provided, these branding elements are default to PINGPAD own banner, logo and slogan.

### 9.2.2. Extension Management

After a subscription is created, the administrator can proceed to set up an extension pool for users within that community. Extension records are not merely directory entries but are active routing objects within the communication control framework. Each extension record contains claim credentials and subscription identifiers used by the call service system to determine signaling destination, group distribution behavior, and admission policy evaluation. When an extension is claimed or released, the modification is immediately reflected in the backend database and affects subsequent call routing and admission decisions executed by the call service system.

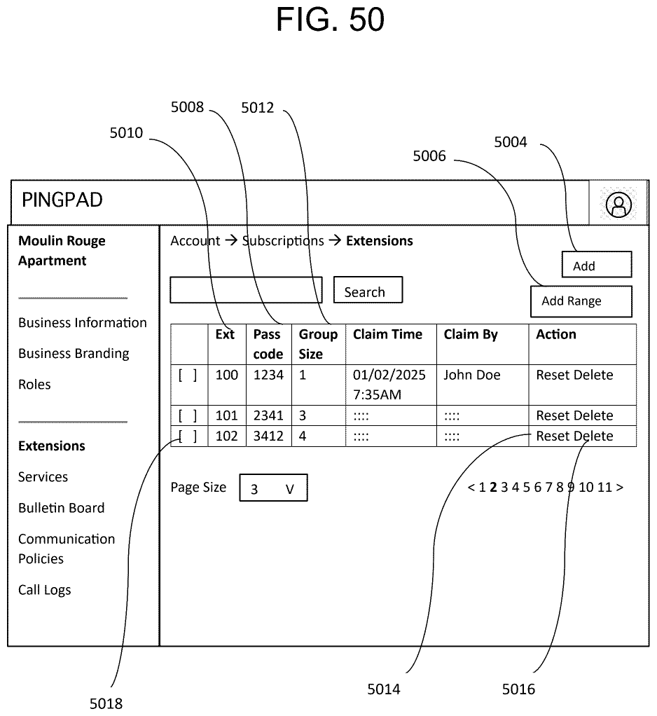

As illustrated in FIG. 50, extensions may be added individually using the Add button (5004) or in bulk using the Add Multiple button (5006), which creates a continuous sequence of extensions. Each extension is represented as an alphanumeric string up to 6 characters (e.g., “100A”, “A100”, or “Sales”) to allow for flexibility to adapt to customer references. Users can self-register by scanning an extension claim tag, a unique QR code generated for each subscription. Upon scanning the claim tag, the user will be led to a web page prompting the user for a passcode (5008) associated with the to-be-claimed extension. If the input passcode is valid, the system will assign the ownership of the extension (5010) associated with the passcode to the user by associating the user id of the user to the extension record.

When an extension is released, the user id field in the corresponding extension record is cleared, and a new passcode is automatically generated for the extension record. This effectively prevents the extension to be reclaimed by the previous owner. Administrators may manually reset or delete extensions using the Reset (5014) or Delete (5016) actions. When an extension is reset or deleted by a subscription administrator, a notification message is sent to the existing owner of the extension to inform the owner of action. An extension is automatically disclaimed when the owner terminates PINGPAD service using the app. The checkbox in front on every entry is used for select an extension for bulk operations such as Delete or Reset. When one or more of these boxes is checked, a dialog box will pop up to prompt the user for actions.

An extension may also be shared among multiple users to form a call group, allowing team-based call handling on the shared extension. This feature is particularly useful for households with multiple family members, collaborated work teams such as sales or support. The ‘Group Size’ column displays the number of users currently sharing an extension.

### 9.2.3. Service Management

In another embodiment, the PingPad system further supports the creation and management of service extensions—contact points for community services such as maintenance, housekeeping, customer support, operator, security, etc. Service extensions represent dynamic routing entities capable of associating multiple attendant devices under a shared call handling group. The service management subsystem stores membership state, availability state, and policy parameters governing how incoming calls are distributed among attendants. When a service attendant checks in or checks out, the system updates availability state in the database. This state information is used by the call service system during signaling progression to determine which devices are eligible to receive signaling messages for an incoming service call. Thus, the service management subsystem directly affects runtime signaling distribution logic.

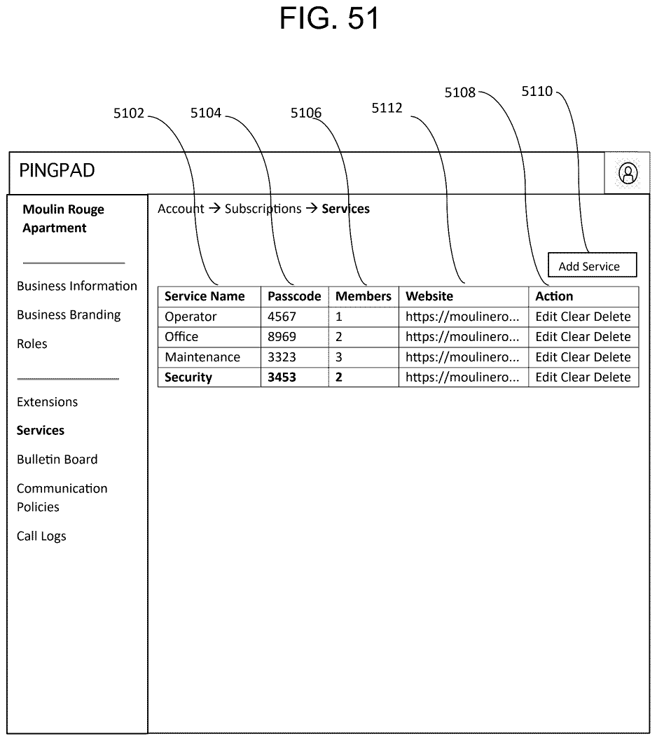

As shown in FIG. 51, the Services screen displays a list of existing service extensions, each identified by a user-friendly service name (5102). Subscription administrator can add new services using the Add Service button (5110) that triggers a popup dialog listing the pre-defined services stored in the services table in the backend for the administrator to select from. This dialog also allows the administrator to create a new service if the desired service was not in the list. Depending on the need to present information of the service on end-user PINGPAD mobile app, the dialog could also include UI elements that allows the administrator to upload banner images representing/advertising the service, a short service description of the service, service open hours along with promotional text and images. The service setup data will be stored in the service table for retrieval by end-user mobile app for browsing.

Service attendants register and claim service extensions by scanning a Service Claim QR code, uniquely created for each subscription, using their own PingPad mobile app. The claiming process is similar to claiming an extension described in an earlier embodiment. Once claimed, they become active members eligible to receive calls directed to that service. Multiple attendants may share a service extension to ensure prompt response times. Alternatively, the service registration can also be arranged to be the exact same method as that of extension registration, i.e. Once the first attendant claims a service, s/he becomes the owner of the extension and later can share the service extension with others in the service group on-demand. Each service entry includes the service name (5102), passcode (5104), and a count of the number of service attendants (5106) signed up for answering service calls. As with extensions, services can be cleared or deleted through the Action control buttons (5108). Clearing a service entry will cause it to be reset to initial empty state. Existing attendant members are removed from answering service calls. Deleting a service will remove it from the service listing. Existing attendant members are also removed from the service. Editing a service will trigger a popup dialog displaying all the information on the service entry. Using this dialog, Administrator can remove one or more registered member of service or switch the owner role between members of the service group.

The Website column (5112) shows a URL leading to a website for each service where PingPad users can browse a list of external service providers along with their offerings in order to pick the most suitable one for own need. Such arrangement would give a whole range of flexibility in handling service requests. For example, instead of being a service provider lookup website, the URL could present a service bidding or comparative service portal where the user could submit a service request on the site and later receive offers from several service providers with quotation through user's email address or portal user interface. Since user's email address is registered with PingPad system, PingPad can handle the forwarding of the offers to the user without exposing the user's contact details to the service providers. Still, the website could also be a hyperlink (URL) leading the user to an AI agent assisting users in locating a service provider through voice conversation. On PingPad mobile app, when the user taps on a service, the app will automatically leads the user to the website if there is no service attendant available to receive a service request call. This design arrangement will allow external, local or nation-wide, service providers to sign up to provide their service to PingPad users. Services that fit this category are, for example, home repair and improvement, moving, transportation, food & drinks, health & wellness services, travel-related services, etc.

A service could be set up with an automated conversational AI agent to act as a call-routing operator. The operator service may function as a centralized call dispatch endpoint. In embodiments incorporating an automated conversational agent, the service management subsystem coordinates interaction between the call service system and AI processing modules. During an operator call session, signaling control is temporarily delegated to an automated agent which performs directory lookup and extension resolution prior to instructing the call service system to modify session routing parameters.

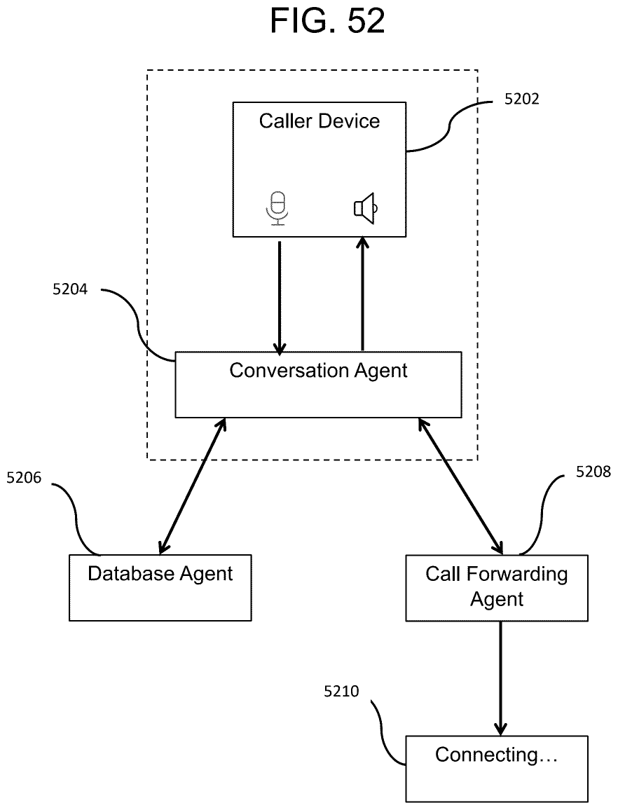

The conversational agent does not merely provide user interface interaction but participates in dynamic modification of call routing instructions within the communication control framework. To set this up, a cloud conversation agent service, e.g. Eleven Labs, is required. This type of AI agent generally handles speech-to-text and text-to-speech conversion, natural language processing, intelligent decision based on an AI model trained to perform specific function(s), e.g. OpenAI, Gemini, Claude, etc. When it is configured to have access to other task-handling AI agents, it also carries out certain tasks based on user's requests. AI agents typically use web API as mechanism for inter-service interface. Those skilled in the art should know how to put these services together to perform one or multiple task as required. For example, Operator service is an ideal scenario to demonstrate the usefulness of AI setup. Refer to FIG. 52, which illustrates a block diagram of the Operator service processing using AI technology to assist users in call forwarding to an extension. In this set up, in addition a conversation agent (5204) to perform voice conversation with the caller (5202), by converting audio signals from the microphone to text for processing and text to audio signals output to the speaker in response, a call forwarding agent (5208) to perform call forwarding action and a database agent (5206) to look up for an extension matching a user-provided name or extension are required. The operation begins with the caller/visitor to place a call to the operator service, defaulted to extension 0, using the PingPad mobile app. This action will trigger the call service server to connect the user to the conversation agent process. The conversation agent process could be a cloud service or it could be a module of PingPad mobile app depending how complex the AI model is. For simple conversation such as an operator service, a small specialized AI agent could be incorporated with the PingPad mobile app as a module. Thus, the conversation agent executes as an external cloud server or internal module depending on implementation. Assuming the conversation is a module of the mobile app, the agent will take control of the microphone and speaker to establish an audio channel with the caller to start the conversation. Microphone output of the caller's device will be captured by the conversation agent and converted to text for processing by the conversation agent and conversation agent response will be converted to audio signals for output on the device's speaker. During the conversation, the caller will be prompted to identify either an extension or user name to connect to. Once the information is given in response, the conversation agent will signal the database agent to verify whether the provided name or extension is correct. If an extension id is returned, the PingPad mobile app uses the returned extension id to forward the call. To forward the call, the PingPad mobile app will send a request signal to the call service server to initiate a call session with the target device, thereby connecting the two devices via audio and video channels. However, if the database lookup operation results in multiple entries, which may happen if the caller provided a name, the conversation agent will engage in further conversation to narrow down a closest match. Similarly, other services can also be setup for similar AI-assisted automated operations. In case, the agent is a cloud service, PingPad mobile app has the direct an audio channel of the call to the agent on the cloud for the agent to initiate the conversation.

### 9.2.4. Bulletin Board

In another embodiment, the present invention is further extended to include a community bulletin board. The Bulletin Board subsystem operates as a distributed notification control component within the communication network. Posts published at the subscription level are stored in backend databases and retrieved by user devices in accordance with subscription identifiers and access control parameters.

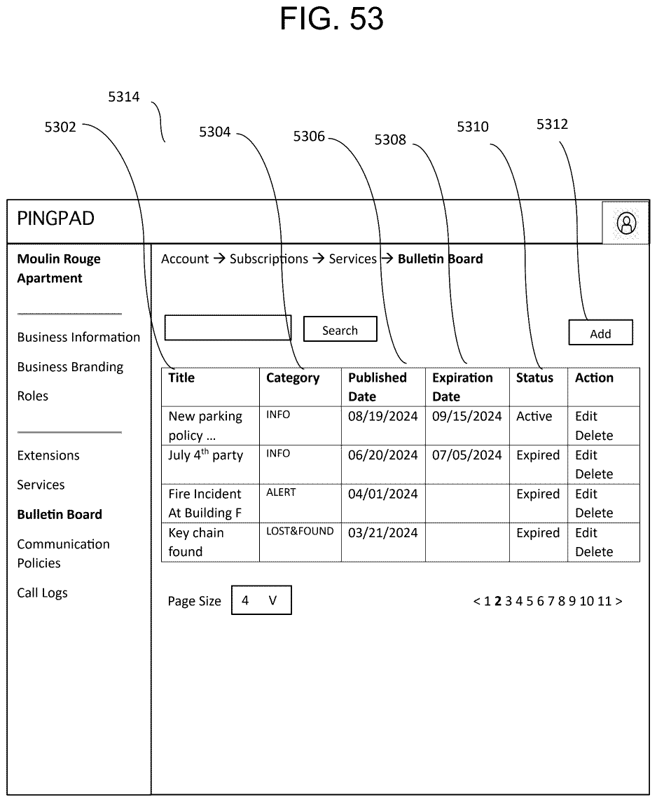

Refer to FIG. 53, the Bulletin Board subsystem allows the subscription administrator to broadcast digital notices, newsletters, or alerts directly to community users via the PingPad mobile app. It is a convenient way for business to go digital and save paper printing and time distributing them. Posts may be created at either the account or subscription level, with account-level messages distributed to all managed subscribed communities, while subscription-level posts will be distributed to users of a specific-subscription only. Each post includes a title (5302), category (5304), publication (5306) and expiration (5308) dates, and a publication status indicators (5310), which indicates whether a publication is Active or Expired. PingPad defines four post categories: Information, News, Alert and Lost&Found. However, subscription administrator can define new categories for local needs. Furthermore, the administrators can edit, or delete posts using the corresponding Action controls. The Add button (5312) is to add a new post. When adding a new post, the administrator will be prompted to specify a post title, select its category from one of the defined categories and an expiration date. The content of the post can be input using a HTML text editor. HTML editor allows the user to perform simple text formatting, including hyperlinking, and insert media content. The size of the included media contents may be limited by system configuration to avoid excessive use of storage. Once the post composition is complete, it could be published immediately or saved as a draft for later publication. The posts are stored in cloud storage service such as Amazon S3 service and, after published and active, qualified for retrieval by end-user PINGPAD mobile app for display.

Active posts are available for retrieval by user devices, while Expired posts will not be qualified for retrieval by the users. When an Alert post is published, it also triggers a push notification to every user of the community. Users can tap the notification to open the full alert post within the mobile app interface. Alert is further categorized into Yellow alert and Red alert. Yellow alert is used for warning events, e.g. neighborhood watch, traffic issues, planned power shutoff, etc., while Red alert is for emergency on-going events such as natural disasters, fires, violence incidents, etc. Both types of alert will cause a notification message to be sent to all users of the subscription via PINGPAD mobile app to alert users of the event in real-time. However, the red alert further triggers automatic playback of an audio version of the alert message to immediately capture the user's attention.

### 9.2.5. Communication Policies

In another embodiment, the subscription management interface further includes a Communication Policies configuration module that enables an authorized administrator to configure operational features and service parameters of the PINGPAD system as made available to end users. These configurable settings govern the behavior of the mobile application and associated call service functions, thereby allowing the administrator to define and enforce communication policies appropriate for the organization. The Communication Policies module stores subscription-level parameters that directly influence:
Whether visual caller identification is inserted into signaling sequences,
Whether trusted users bypass preview state,
Whether directory visibility is enabled,
Whether centralized dispatch routing is applied,
Whether service calls are distributed to attendant groups.

Upon update, these parameters are retrieved by the policy control engine during evaluation of call initiation requests, thereby affecting real-time signaling progression and media channel allocation.

The system may be deployed across a variety of organizational environments, industries, and operational models. Accordingly, the Communication Policies module may provide flexible configuration options to accommodate differing security requirements, privacy preferences, and communication workflows.

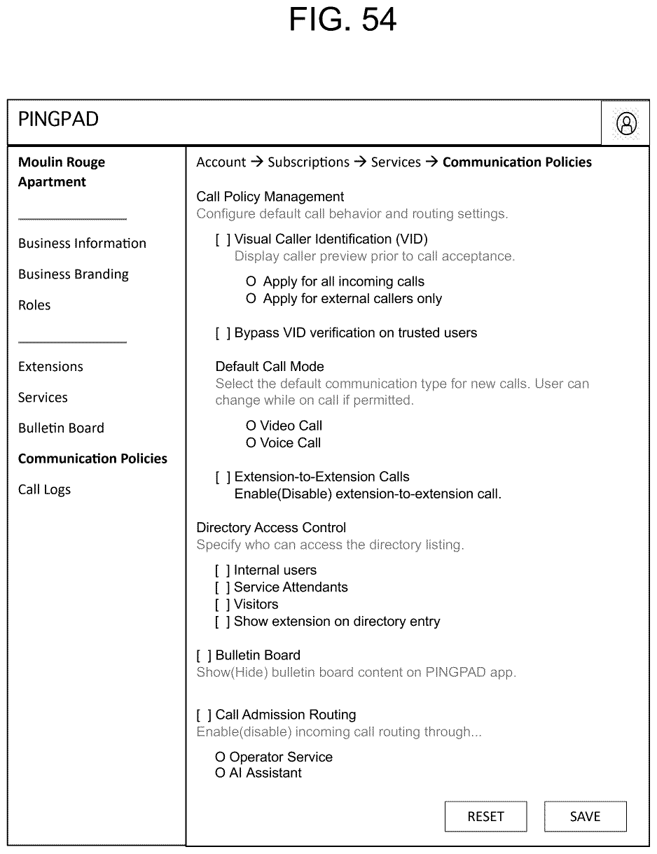

Referring to FIG. 54, an example configuration interface is illustrated showing selectable call management and system features. In the call management section, the administrator may specify whether a visual caller identification feature is enabled for incoming calls, and if enabled, whether such feature applies to all incoming calls or only to calls originating from external users. The administrator may further define a default call mode, such as video or audio, for newly initiated communication sessions. Additionally, the administrator may determine whether users within the same organization are permitted to initiate calls to one another, thereby enabling or restricting internal communication based on organizational policy.

In certain embodiments, the system also provides support for a directory listing of registered users and extensions, including service extensions. Access to the directory listing may be selectively restricted by the administrator to specified user groups in accordance with privacy or operational considerations. The administrator may also configure whether extension identifiers are displayed within directory entries. The system may further support presentation of bulletin board content within the mobile application. Such functionality may be enabled or disabled based on organizational preference. In some embodiments, incoming external calls may be routed through a centralized call handling mechanism. The administrator may configure whether such per-subscription centralized handling is provided and, if enabled, whether calls are processed by a live operator or by an automated assistant implemented using artificial intelligence techniques.

### 9.2.6. Call Logs

In certain embodiments, communication sessions processed by the PINGPAD system are recorded and stored in a call log database for audit, monitoring, and analytical purposes. The Call Logs subsystem stores signaling metadata and media session attributes associated with completed or terminated communication sessions. Stored data includes session initiation timestamps, termination states, routing paths, and policy decision outcomes. This data may be aggregated and analyzed to refine subscription-level policy parameters and optimize signaling behavior, thereby forming a feedback mechanism between operational analytics and communication control logic.

The service system provides a call log management interface that enables an authorized subscription administrator to access, browse, and query stored call records. Such queries may be performed based on one or more parameters including caller information, callee information, call duration, call status, timestamps, or other associated metadata. With such data, the system further includes facility to generate usage reports, including periodic summaries of call activity for billing, accounting, or operational review purposes. In some embodiments, call log data may also be aggregated and processed to generate dashboard displays summarizing call activity over a specified time interval, thereby enabling monitoring of communication patterns and system utilization.

### 10. PingPad Mobile Application

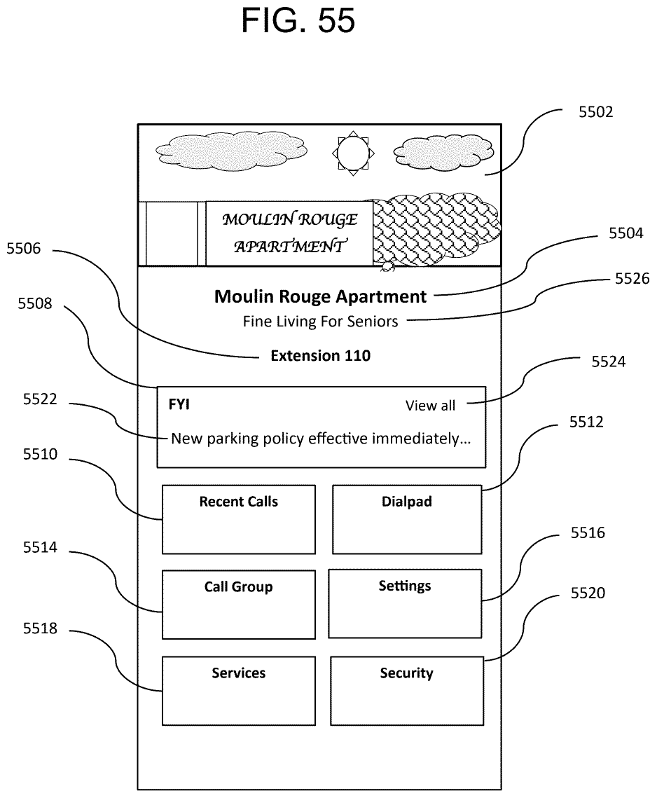

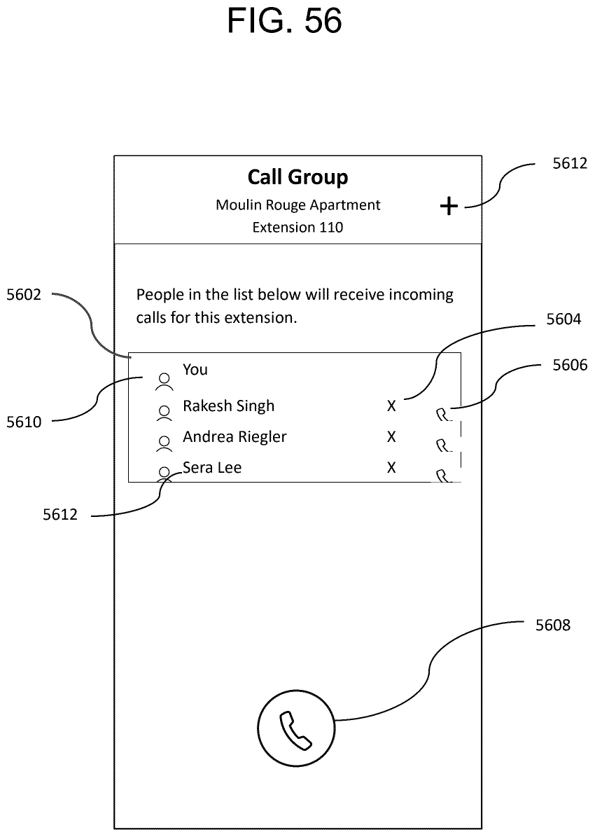

The PingPad mobile app serves as the primary end-user interface for placing and receiving calls within the PingPad network. After registration and extension claiming, the app automatically configures itself according to the associated subscription. As illustrated in FIG. 55, the app's Home screen displays the business banner (5502), name (5504), slogan (5526), and the user's extension (5506). Below this section, a Bulletin Board summary window (5508) cycles through a list of currently active posts. Users may tap a post title for details or view all posts using the View All link (5424). The lower section of the screen includes key buttons such as Recent Calls (5310), Dialpad (5512), CallGroup (5514), Settings (5516), Services (5518), and Security (5520). The Dialpad supports alphanumeric input for placing internal calls by entering extension number as illustrated in FIG. 56. The Call Group button displays a list of members (5602) sharing an extension and provides options to add (5612), remove (5604), or call (5606) specific members. Each member entry begins with the corresponding user's avatar (5610) followed by the user name (5612) and a Delete (5604) and a Call (5606) button. It is noted that the Delete button is shown only on extension owner's screen, since only the extension owner has the authority to manage own call group member list.

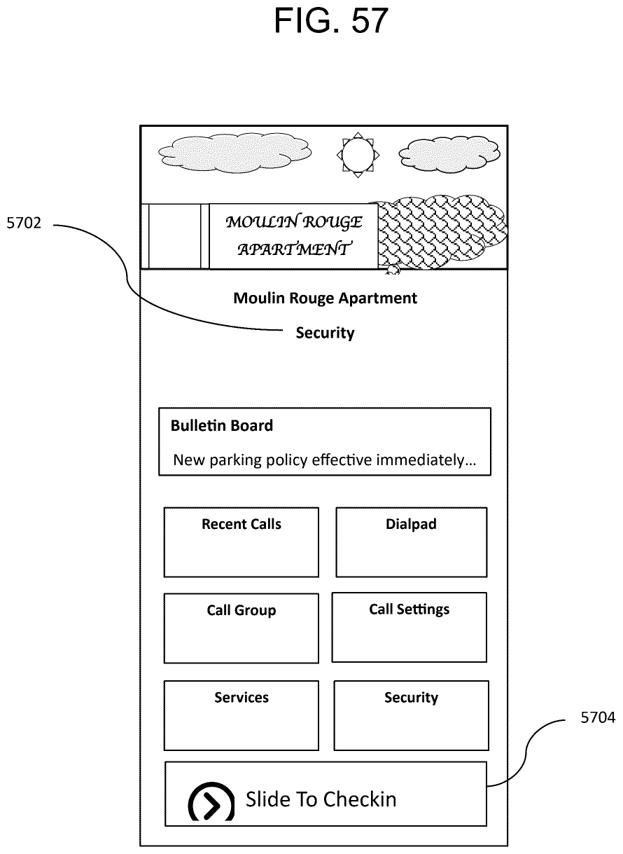

Service attendants use the same PingPad mobile app to receive service calls. On attendant device, refer to FIG. 57, the Home screen displays the service name (5702) and includes a Check-In/Check-Out switch (5704) to manage service availability. Check in/out status is used by the system to determine whether a service calls should be routed to the device. When an attendant starts his/her shift, the attendant will check in to begin receiving service calls. After the attendant checks out at end of the shift, the attendant's device will stop receive service calls. The check in/out time is recorded in the time-tracking table for book-keeping and audit by the management.

The embodiments described herein illustrate representative implementations of a cloud-managed communication control system that integrates machine-readable call initiation, subscription-based routing, and configurable call admission mechanisms. The described processing flows, signaling control operations, database structures, and user interface arrangements are provided for purposes of explanation and are not intended to limit the scope of the invention. The underlying communication sessions may be implemented using packet-based real-time communication protocols, including peer-to-peer or server-centric architectures. Those skilled in the art will recognize that equivalent signaling mechanisms, session control frameworks, or communication transport protocols may be employed without departing from the principles disclosed herein. All communication channels, including signaling exchanges, audio streams, video streams, and associated data transmissions, may be secured using established encryption and authentication techniques.

Although individual embodiments have been described separately for clarity, the disclosed features may be selectively combined, reconfigured, or extended in alternative implementations. For example, routing mechanisms, preview states, policy evaluation criteria, notification subsystems, and device-level behavioral controls may be implemented independently or in combination depending on application requirements.

Furthermore, since PingPad is a real-time control system, any changes in subscription-level or system-level configurations will take effect immediately on the policy control engine and the operations of the mobile app. For example, if a service is activated or deactivated, the user will observe the service availability in real-time via PingPad mobile app, or any changes to call configuration such as switching call mode from audio to video or vice versa will have immediate effect on the next call sessions, or the addition or removal of an extension, will also have immediate impact on the directory listing.

The invention is not limited to residential or building access scenarios and may be applied to a wide range of communication environments including organizational, institutional, commercial, mobile workforce, and distributed service contexts. The scope of the invention is defined by the appended claims and includes modifications and equivalents that fall within the spirit of the disclosed subject matter.

1) A computer-implemented method for controlling establishment of a real-time communication session over a packet data network between a caller device and a recipient device, the method being performed by a call service system comprising one or more processors and memory storing executable instructions, the method comprising:
a) receiving, by the call service system, a call initiation request generated by the caller device in response to resolution of a network-resolvable link encoded in a call tag associated with a user profile, extension profile, or community subscription;
b) receiving, with the call initiation request, caller identification data comprising at least one of a caller user identifier, device identifier, temporary session identifier, or facial characteristic data derived from image data captured by an image sensor of the caller device;
c) prior to allocation of signaling or media channel resources for establishing the real-time communication session, providing the call initiation request and caller identification data to a policy control engine;
d) accessing, by the policy control engine, a plurality of independent policy criteria comprising:
i) per-recipient blacklist records, ii) system-wide historical block threshold data, iii) subscription-level configuration parameters, and iv) trust classification data;
e) evaluating the plurality of independent policy criteria in combination to generate a multi-state call control signal specifying one of:
i) termination of the call initiation request without presenting the call to the recipient device, ii) automatic progression to signaling establishment without requiring a visual caller identification procedure, or iii) insertion of a preview state requiring transmission of a live video stream prior to permitting call acceptance;
f) modifying, by the call service system, a signaling sequence of a session establishment protocol in accordance with the multi-state call control signal; and
g) selectively establishing or withholding allocation of audio and/or video media channels between the caller device and the recipient device in accordance with the modified signaling sequence.

2) The method of claim 1, wherein:
a) the facial characteristic data is compared against stored facial characteristic records associated with previously blocked callers;
b) the system-wide historical block threshold data causes automatic termination when the caller exceeds a predefined block count across multiple recipients;
c) subscription-level configuration parameters define whether trusted callers bypass the preview state; and
d) signaling messages are suppressed prior to notification of the recipient device when termination is specified.

3) The method of claim 1, further comprising dynamically updating subscription-level configuration parameters via a cloud-based service management subsystem.

4) The method of claim 1, wherein the preview state requires transmission of a live video stream prior to enabling call acceptance controls on the recipient device.

5) The method of claim 1, further comprising associating a call tag or extension identifier with a plurality of recipient devices to define a call group and distributing signaling messages to the plurality of recipient devices in accordance with a stored group-handling rule.

6) The method of claim 5, wherein the stored group-handling rule specifies concurrent signaling to the plurality of recipient devices while restricting establishment of a media channel to a first device that accepts the call.

7) The method of claim 5, wherein the stored group-handling rule specifies concurrent signaling to the plurality of recipient devices and permitting establishment of media channels with multiple recipient devices to form a multi-party communication session.

8) The method of claim 5, wherein the stored group-handling rule specifies sequential signaling to recipient devices according to a predefined order.

9) The method of claim 1, further comprising modifying signaling destination data to transfer an active communication session between devices associated with a common call tag without terminating the communication session at the call service system.

10) The method of claim 1, further comprising allocating additional media channels to additional recipient devices to form a multi-party communication session during an active communication session.

11) The method of claim 1, wherein incoming external call requests are first directed to a centralized dispatch endpoint prior to routing to the recipient device.

12) The method of claim 11, wherein the centralized dispatch endpoint comprises an automated conversational agent configured to:
a) receive audio input from the caller device;
b) convert the audio input to machine-readable data;
c) determine a routing destination based on the machine-readable data; and
d) transmit a routing instruction to the call service system.

13) The method of claim 12, wherein the call service system modifies signaling destination parameters in response to the routing instruction without requiring initiation of a new call session.

14) The method of claim 1, wherein subscription-level configuration parameters are provisioned via a cloud-based service management subsystem and applied by the policy control engine at runtime.

15) An integrated communication control system for governing real-time communication sessions across multiple subscription domains, comprising:
a) a call service system comprising one or more processors configured to execute signaling procedures for establishing, modifying, or terminating real-time communication sessions between caller devices and recipient devices;
b) a policy control engine communicatively coupled to the call service system and configured to evaluate subscription-specific call admission criteria prior to media channel allocation;
c) a service management subsystem comprising a cloud-based administration interface and a configuration database configured to:
i) provision multiple community subscriptions, ii) store subscription-level communication policies, routing definitions, and trust classifications, and iii) propagate updated configuration parameters to the call service system for runtime application;
d) a routing control module configured to associate extensions and service identifiers with one or more devices and distribute signaling messages based on stored routing definitions and device availability state; and
e) a notification control subsystem configured to transmit subscription-based alert notifications to user devices and trigger automated device-level behavioral responses based on alert classification;
wherein the service management subsystem operates as a control-plane provisioning layer dynamically governing runtime signaling behavior across the multiple subscription domains.

16) The system of claim 15, wherein the policy control engine modifies signaling progression states prior to allocation of communication resources.

17) The system of claim 15, wherein routing definitions include multi-device call group distribution stored in the configuration database.

18) The system of claim 15, wherein alert classifications include emergency-level alerts that trigger automatic playback of audio content on recipient devices.

19) The system of claim 18, further comprising an analytics module configured to collect signaling metadata and media session attributes for refinement of subscription-level policies.

20. A smart call board device for initiating communication sessions through the communication control system of claim 15, comprising:
a) a processor;
b) a network interface configured to communicate with a call service system;
c) a touchscreen display configured to present a dynamically updateable QR code associated with a community subscription;
d) a microphone and speaker configured to support two-way audio communication; and
e) optionally, a camera module configured to capture live image or video of a visitor,
wherein the processor is configured to:
i) receive visitor input including extension selection or directory lookup;
ii) transmit a call initiation request to the call service system; and
iii) operate in accordance with signaling and routing instructions received from the call service system.

21. The device of claim 20, wherein the display further comprises:
a) a dialpad control for presenting a dialpad interface for initiating a call via user input of an extension or selection of an entry from a directory listing;
b) an operator control for initiating a call to an operator service for a live or automated operator; and
c) a security control for initiating a call to a security service.

22) The device of claim 20, wherein the camera module supports continuous environmental monitoring.
